(19) United States
(12) Patent Application Publication
(10) Pub. No.: US 2014/0059460 A1
(43) Pub. Date: Feb. 27, 2014

(54) METHOD FOR DISPLAYING GRAPHICAL USER INTERFACES AND ELECTRONIC DEVICE USING THE SAME

(71) Applicant: EGALAX_EMPIA TECHNOLOGY INC., Taipei City (TW)

(72) Inventor: SHUN-LUNG HO, TAIPEI CITY (TW)

(73) Assignee: EGALAX_EMPIA TECHNOLOGY INC., Taipei City (TW)

(21) Appl. No.: 13/974,176

(22) Filed: Aug. 23, 2013

(30) Foreign Application Priority Data
Aug. 23, 2012 (TW) 101130558

(51) Int. Cl. G06F 3/048

(52) U.S. Cl. CPC G06F 3/048
USPC 715/766

(57) ABSTRACT

The invention provides an electronic device for displaying GUIs (graphical user interfaces) including a touch screen and a processor. The touch screen displays one or more of a plurality of GUIs and detects a first and a second touch signal. When the processor determines the first touch signal existing at the overlap of the GUIs and the second touch signal, switches the top GUI to another GUI based on the relative positions between the first and the second touch signals or the direction in which the second touch signal is moving.

### CROSS REFERENCE TO RELATED APPLICATIONS

This application claims priority under 35 U.S.C 119 to Taiwan patent application, TW 101130558, filed on Aug. 23, 2012, the disclosure of which is incorporated herein by reference.

### BACKGROUND OF THE INVENTION

1. Field of the Invention

The present invention relates to a method for displaying graphic user interfaces (GUIs), and more particularly, to a method for displaying GUIs and an electronic device using the same.

2. Description of the Prior Art

In order to keep up with the modern busy pace of life, various compact and portable electronic devices are being developed. Personal digital assistants (PDA) and PDA phones, for example, not only have the functions of traditional communication devices, but also allow users to create files, send and receive e-mails, browse Internet, use instant messaging software and so on through its built-in operating system. In other words, such portable electronic devices not only can be used to make a call, but also provide a variety of diverse functions like small PCs. With the advances in wireless network technology, the use of these features is no longer subject to the restrictions in time and space, this kind of devices has become an indispensable tool in the modern life where efficiency is very important.

However, for portable electronic devices that require lightweight and compact form factor, their volume is subject to considerable restrictions. If a screen and a keyboard are to be provided on such a device, the size of the screen has to be reduced. In order to maximize the screen size in a limited space, a touch screen has recently been developed, which integrates the keyboard into the screen to become an input interface for the portable electronic device, thereby eliminating the cost and footprint for installing a traditional physical keyboard.

Compared to the traditional keyboard input method, the operations of a touch screen is relatively simpler and more intuitive. For example, it can be observed that when a user is using a traditional keyboard to operate the electronic device, he/she has to press the required keypad(s) while referring to the display on the screen at the same time, so as to successfully complete actions such as text input or menu switching. However, in the case that a touch screen is installed on the electronic device, the user can perform operations by directly selecting with a stylus or pressing with his/her finger an icon/image on the screen. It can be seen that touch screens provides a more convenient way of input.

However, the sizes of the touch screens on the portable electronic devices are still relatively limited with respect to a wide range of functionalities that can be provided by the portable electronic devices. In order to offer selections of a large amount of features on a size-limited screen, most of the commercial mobile phones employ a graphical operating interface, which represents various functionalities by icons and arranges these icons in the touch screen.

FIG. 1 is a schematic diagram depicting a prior-art graphical operating interface. Referring to FIG. 1, a graphical operating interface 100 divides a touch screen of a portable electronic device into a plurality of display areas, and various representative icons such as Home 110, Contact 120, SMS 130, E-mail 140, Camera 150, Music 160, Internet 170, Weather 180, Set up 190 are shown in these areas. This arrangement allows a user to see all the functionalities provided by the portable electronic device in one glance, but once the user selects and enters into an operating interface represented by a specific icon, only a single functionality is available for operation. If the user wishes to switch to another function, then he/she has to return to the original graphical operating interface 100 to select another icon, which is not very convenient.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

In order to achieve the above or other objectives, the present invention proposes a method for switching the display of GUIs, which includes the following steps of: displaying one or more of a plurality of GUIs stacked together on a touch screen, wherein these GUIs are arranged in a sequential order, which defines a GUI preceding and/or a GUI following the GUI at the topmost layer; and when a second touch signal is detected by the touch screen while a first touch signal continuously exists in the overlapping area of the GUIs, switching the topmost GUI according to the relative locations between the first and second touch signals or the direction in which the second touch signal is moving, wherein the switching of the topmost GUI is performed when the second touch signal appears or disappears.

According to the above method for switching the display of GUIs, the present invention further proposes an electronic device for displaying GUIs, and this electronic device includes a touch screen and a processor. The touch screen can be made of a touch panel with a display integrated by add-on or combined together in the manufacturing process of the display, forming such as an “on-cell” touch screen or “in-cell” touch screen.

The touch screen displays one or more of a plurality of GUIs cascaded together (overlapped or stacked), and detects a first touch signal and a second touch signal, wherein the GUIs are arranged in a sequential order, which defines a GUI preceding and/or a GUI following the topmost GUI. The processor determines if the first touch signal is in an overlapping area of these GUIs, and when detecting the second touch signal while determining that the first touch signal continues to exist in the overlapping area, it switches the topmost GUI according to the relative locations between the first and second touch signals or the direction in which the second touch signal is moving, wherein the switching of the topmost GUI is performed when the second touch signal appears or disappears. The GUIs can be images displayed in the operating system of the touch screen or display output of applications, for example, the windows of the applications or non-window type image or videos played. The present invention does not limit the presentation formats of these GUIs.

The present invention further proposes a method for displaying graphical user interfaces (GUIs), comprising: displaying one of a plurality of GUIs on a touch screen, the GUIs being arranged in a sequential order which defines a GUI preceding and/or a GUI following the currently displayed GUI; and when pressing, lifting, sliding or sliding in air of a second external object is detected after a first external object has pressed down, and that there is a GUI following the currently displayed GUI, displaying the GUI following the currently displayed GUI.

Accordingly, the present invention also proposes a device for displaying graphical user interfaces (GUIs), comprising: a touch screen for displaying one of a plurality of GUIs, the GUIs being arranged in a sequential order which defines a GUI preceding and/or a GUI following the currently displayed GUI; and a processor for displaying, when detecting pressing, lifting, sliding or sliding in air of a second external object after a first external object has pressed down, and when there is a GUI following the currently displayed GUI, the GUI following the currently displayed GUI.

The present invention further proposes a method for displaying graphical user interfaces (GUIs), displaying one of a plurality of GUIs on a touch screen, the GUIs being arranged in a sequential order which defines a GUI preceding and/or a GUI following the currently displayed GUI; and when sliding forward or sliding forward in air of a second external object is detected after a first external object has pressed down, and that there is a GUI preceding the currently displayed GUI, displaying the GUI preceding the currently displayed GUI.

Accordingly, the present invention also proposes a device for displaying graphical user interfaces (GUIs), comprising: a touch screen for displaying one of a plurality of GUIs, the GUIs being arranged in a sequential order which defines a GUI preceding and/or a GUI following the currently displayed GUI; and a processor for displaying, when sliding forward or sliding forward in air of a second external object is detected after a first external object has pressed down, and when there is a GUI preceding the currently displayed GUI, the GUI preceding the currently displayed GUI.

The present invention further proposes a method for displaying graphical user interfaces (GUIs), comprising: displaying one of a plurality of GUIs on a touch screen, the GUIs being arranged in a sequential order which defines a GUI preceding and/or a GUI following the currently displayed GUI; and when lifting, sliding or sliding in air of a second external object is detected after a first external object and the second external object have simultaneously pressed down, and that there is a GUI following the currently displayed GUI, displaying the GUI following the currently displayed GUI.

Accordingly, the present invention also proposes a device for displaying graphical user interfaces (GUIs), comprising: a touch screen for displaying one of a plurality of GUIs, the GUIs being arranged in a sequential order which defines a GUI preceding and/or a GUI following the currently displayed GUI; and a processor for displaying, when lifting, sliding or sliding in air of a second external object is detected after a first external object and the second external object have simultaneously pressed down, and that there is a GUI following the currently displayed GUI, the GUI following the currently displayed GUI.

The present invention further proposes a method for displaying graphical user interfaces (GUIs), comprising: displaying a plurality of GUIs on a touch screen, when two or more of the GUIs overlap with each other, these GUIs being arranged in a sequential order which defines a GUI preceding and/or a GUI following the first GUI in the sequential order, wherein the first GUI in the sequential order covers all the following GUIs; and when pressing, lifting, sliding or sliding in air of a second external object is detected by the touch screen after a first external object has pressed down, and that the pressing of the first external object and/or the pressing, lifting, sliding or sliding in air of the second external object is/are in an overlapping area of two or more GUIs, changing the order of the GUIs in the overlapping area, and thus changing the display of the GUIs.

Accordingly, the present invention also proposes a device for displaying graphical user interfaces (GUIs), comprising: a touch screen for displaying a plurality of GUIs, when two or more of the GUIs overlap with each other, these GUIs being arranged in a sequential order which defines a GUI preceding and/or a GUI following the first GUI in the sequential order, wherein the first GUI in the sequential order covers all the following GUIs; and a processor for changing the order of the GUIs in the overlapping area when pressing, lifting, sliding or sliding in air of a second external object is detected by the touch screen after a first external object has pressed down, and that the pressing of the first external object and/or the pressing, lifting, sliding or sliding in air of the second external object is/are in an overlapping area of two or more GUIs, and thus changing the display of the GUIs.

The present invention further proposes a method for displaying graphical user interfaces (GUIs), comprising: displaying a plurality of GUIs on a touch screen, when two or more of the GUIs overlap with each other, these GUIs being arranged in a sequential order which defines a GUI preceding and/or a GUI following the first GUI in the sequential order, wherein the first GUI in the sequential order covers all the following GUIs; and when sliding forward or sliding forward in air of a second external object is detected by the touch screen after a first external object has pressed down, and that the pressing of the first external object and/or the sliding forward or sliding forward in air of the second external object is/are in an overlapping area of two or more GUIs, changing the order of the GUIs in the overlapping area, and thus changing the display of the GUIs.

Accordingly, the present invention also proposes a device for displaying graphical user interfaces (GUIs), comprising: a touch screen for displaying a plurality of GUIs, when two or more of the GUIs overlap with each other, these GUIs being arranged in a sequential order which defines a GUI preceding and/or a GUI following the first GUI in the sequential order, wherein the first GUI in the sequential order covers all the following GUIs; and a processor for changing the order of the GUIs in the overlapping area when sliding forward or sliding forward in air of a second external object is detected by the touch screen after a first external object has pressed down, and that the pressing of the first external object and/or the sliding forward or sliding forward in air of the second external object is/are in an overlapping area of two or more GUIs, and thus changing the display of the GUIs.

The present invention further proposes a method for displaying graphical user interfaces (GUIs), comprising: displaying a plurality of GUIs on a touch screen, when two or more of the GUIs overlap with each other, these GUIs being arranged in a sequential order which defines a GUI preceding and/or a GUI following the first GUI in the sequential order, wherein the first GUI in the sequential order covers all the following GUIs; and after a first external object and a second external object have simultaneously pressed down, lifting, sliding or sliding in air of the second external object is detected by the touch screen, and that the pressing of the first external object and/or the pressing, lifting, sliding or sliding in air of the second external object is/are in an overlapping area of two or more GUIs, changing the order of the GUIs in the overlapping area, and thus changing the display of the GUIs.

Accordingly, the present invention also proposes a device for displaying graphical user interfaces (GUIs), comprising: a touch screen for displaying a plurality of GUIs, when two or more of the GUIs overlap with each other, these GUIs being arranged in a sequential order which defines a GUI preceding and/or a GUI following the first GUI in the sequential order, wherein the first GUI in the sequential order covers all the following GUIs; and a processor for changing the order of the GUIs in the overlapping area, after a first external object and a second external object have simultaneously pressed down, lifting, sliding or sliding in air of the second external object is detected by the touch screen, and that the pressing of the first external object and/or the pressing, lifting, sliding or sliding in air of the second external object is/are in an overlapping area of two or more GUIs, and thus changing the display of the GUIs.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram depicting a graphic operating interface of the prior art;

FIGS. 2A, 2B, 2C, 2D, 3A, 3B, 3C, 3D, 4A, 4B, 4C, 4D, 4E, 4F, 5A, 5B, 5C, 5D, 5E, 5F, 5G, 6A, 6B, 6C, 6D and 14 are schematic diagrams illustrating operations of GUIs in accordance with the present invention;

FIGS. 7A and 7B are schematic diagrams showing representative icons in accordance with the present invention;

FIGS. 8A and 8B are schematic diagrams depicting electronic devices capable of displaying GUIs in accordance with the present invention;

FIGS. 9, 10, 11, 12, 13A, 13B, 13C, 13D, 13E, 15 and 16 are flow charts illustrating methods for displaying GUIs in accordance with the present invention; and

FIGS. 17A, 17B, 17C, 17D, 17E and 17F are schematic diagrams depicting operating gestures in accordance with the present invention.

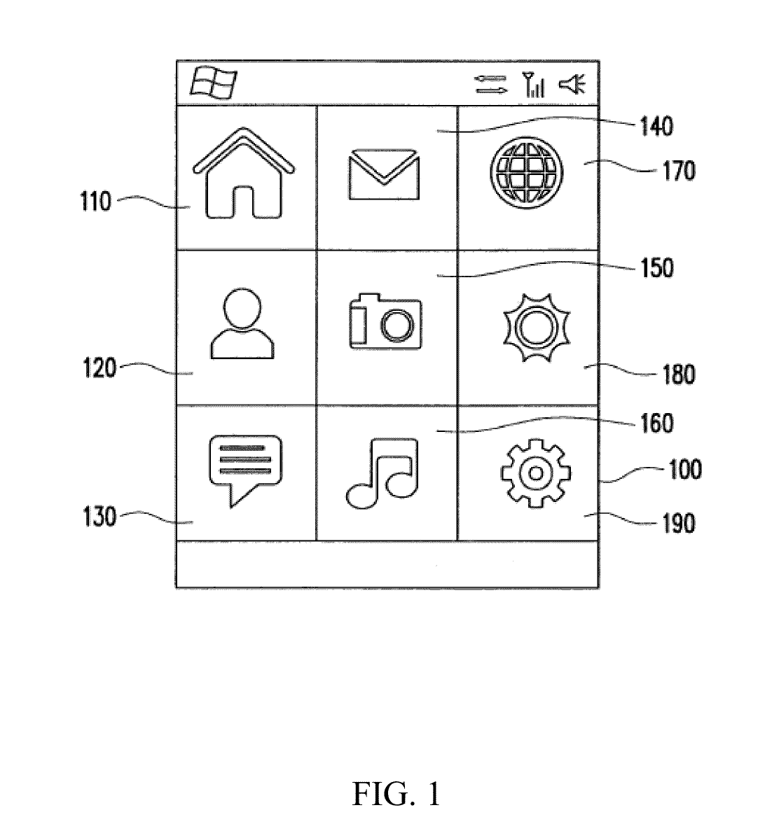

### DETAILED DESCRIPTION OF THE PREFERRED EMBODIMENTS

A Graphic User Interface (GUIs) provides a friendly communication environment between an electronic device and users, when used together with touch screen, provides a more intuitive and convenient human-machine interface. However, the display range of the touch screen is limited, when a user launches several applications at the same time, it might not be possible to display the complete GUIs of each application simultaneously, rather, only one of them is displayed, or the GUIs of these applications are displayed overlapping each other. When more than two GUIs are overlapped, in order to present the overlapping relationship or order among these GUIs, the GUI on the topmost layer covers the GUIs below it in an opaque or translucent way. In the overlapped areas, an opaque appearance displays only the GUI on the topmost layer, whereas a translucent appearance allows the colors of the GUIs on the upper and lower layers to blend with a certain ratio, thereby allowing the display of several GUIs in the overlapped areas simultaneously.

When the touch screen displays in an opaque way or that the translucent appearance does not provide a clear display of the GUIs at different layers, if a lower GUI is to be looked at or operated on, moving this lower GUI above an upper GUI is a preferred method. The upper and lower GUIs herein refer to the overlapping relationship or order of two GUIs. One with ordinary skill in the art can appreciate that the number of overlapped GUIs can be two or three or more, the use of the terms “upper” and “lower” is for illustrative purpose only, and should not be construed in a limiting sense. Accordingly, when a lower GUI is to be looked at or operated on, moving the lower GUI above the upper GUI means moving a GUI below (directly underneath or covered by) the topmost GUI to the top to become the current topmost GUI covering one or more overlapped GUI(s).

In general, GUIs are often presented in windows. When the windows corresponding to several opened applications overlap each other, gesture operations can be performed at the overlapping area of the windows to quickly switch between them. When the touch screen detects a pressing signal in the overlapping area, (for example, when at least one finger or a stylus is pressing continuously on an overlapping point of the windows on the touch screen) and a clicking signal is detected at one side of the pressing signal (for example, at least one finger or a stylus clicks on the touch screen), each time the clicking signal is generated, the overlapped windows are switched once in sequence in an order. When the clicking signal is generated at the other side of the pressing signal, each time the clicking signal is generated, the overlapped windows are switched once in sequence in a reversed order. When a touch signal is detected on the touch screen over a predetermined period of time, the signal is determined to be the above pressing signal. When the duration of a touch signal is detected to be less than the predetermined period of time, the signal is determined to be the above clicking signal.

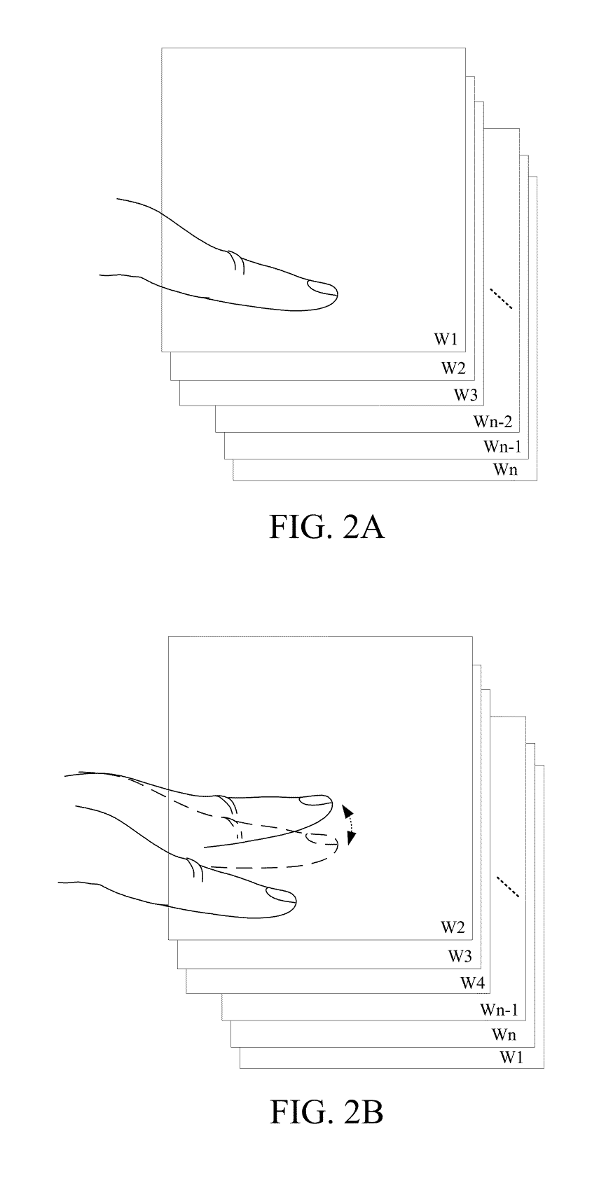

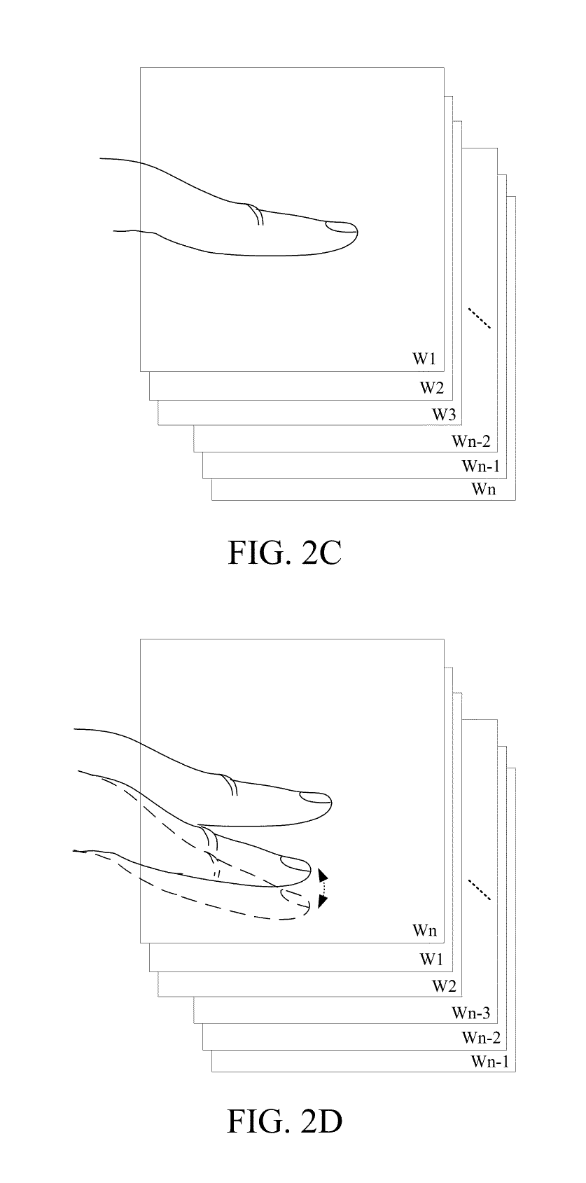

First, as shown in FIG. 2A, a right finger is pressing on the overlapping area of the windows. Then, as shown in FIG. 2B, each time a left finger clicks the touch screen; these windows are switched in sequence in a particular order. Similarly, as shown in FIG. 2C, firstly, the left finger is pressing on the overlapping area of the windows. Then, as shown in FIG. 2D, each time the right finger clicks the touch screen; these windows are switched in sequence in a reversed order. In addition, more fingers can perform the switching of the windows. For example, two fingers can press continuously on the overlapping area of the windows, and then at least one finger clicks the left or right side of the pressing fingers once to switch these windows in a particular order.

When the above pressing and clicking signals are exerted on a larger-sized electronic device (e.g. a tablet PC), then the screen can usually display more than one GUI (window). When these windows overlap with each other, not every window completely overlaps with each other, so the pressing signal at the overlapping area of the windows enables the switching of the overlapping windows. However, since the sizes of the touch screens for mobile phones are usually smaller, if several fingers are used for window switching, sometimes it is possible for all the fingers to press and click on the overlapping area at the same time, so it is also proposed that only the pressing finger needs to be in the overlapping area of the windows, the clicking finger does not need to be in the overlapping area to trigger the switching of the windows, that is, only a pressing signal is needed to be generated in the overlapping area of the windows, the clicking signal can be generated at anywhere on the touch screen to effect the window switching operation. Moreover, since the sizes of the touch screens for mobile phones are smaller, if several GUIs are opened, some mobile phones only display the topmost GUI (window), which effectively means that all GUIs completely overlap with each other. In this case, when the pressing signal and the clicking signal are exerted on the topmost GUI, they are effectively on the overlapping area of the windows.

To perform window switching, these windows are first defined into an ordered list based on the stacking order in space or the order in which these windows are opened in time. Take the example in which the ordered list is defined according to the stacking order in space, upon generation of a pressing signal at the overlapping area of the stacked windows, the ordered list is generated, or upon generation of both a pressing signal and a clicking signal at the overlapping area of the stacked windows, the ordered list is generated, and the subsequent window switching is then performed. For example, referring to FIGS. 2A and 2C as an example, there are n opened and stacked windows from the topmost window (currently displayed window W1 on the touch screen) to the bottommost window (window Wn closest to the desktop); these are window W1, window W2 . . . window Wn−1, and window Wn, respectively. When a pressing signal is exerted at the overlapping area of the stacked windows, these windows form an ordered list of W1, W2, W3 . . . Wn−2, Wn−1, and Wn.

When a clicking signal is exerted at one side of the pressing signal, the windows displayed by the touch screen are switched in a ascending order according to the ordered list of W1, W2, W3, . . . Wn−2, Wn−1, and Wn. Conversely, when a clicking signal is exerted at the other side of the pressing signal, the windows displayed by the touch screen are switched in a descending order according to the ordered list of W1, W2, W3, . . . Wn−2, Wn−1, and Wn. More specifically, for example, when a clicking signal is exerted at one side of the pressing signal, the topmost window is switched from window W1 to W2, as shown in FIG. 2B. Thereafter, when another clicking signal is exerted at one side of the pressing signal, the topmost window is switched from window W2 to W3. As such, after the clicking signal is generated at one side of the pressing signal n−1 times, the topmost window becomes window Wn, as shown in FIG. 2D. On the contrary, when a clicking signal is exerted at the other side of the pressing signal, the topmost window is switched from window W1 to Wn. Thereafter, when another clicking signal is exerted at the other side of the pressing signal, the topmost window is switched from window Wn to Wn−1. As such, after the clicking signal is generated at the other side of the pressing signal n−1 times, the topmost window becomes window W2.

In addition to switching the windows by clicking, sliding motion can be used to trigger window switching. When the touch screen detects a touch signal has moved across a predetermined distance or more, then this touch signal is determined to be a sliding signal, and switching in the ascending or descending order is based on the relative locations between the sliding signal and the pressing signal, or based on the direction of motion of the sliding signal. For example, when a right finger is continuously pressing on the overlapping area of the windows, and then a left finger slides across the touch screen, each time the left finger slides across a predetermined distance, the windows are switched once according to the ordered list in the ascending order. Similarly, each time the right finger slides across a predetermine distance while the right finger is pressing on the touch screen, the windows are switched according to the ordered list in the descending order.

According to the above, the present invention proposes a method for switching between GUIs. First, a plurality of GUIs is displayed in a stack on a touch screen. Then, when the touch screen detects a pressing signal on an overlapping area of these GUIs, and a clicking/sliding signal, the order of the GUIs are defined in an ordered list, and the topmost GUI is switched according to relative locations between the clicking/sliding signal and the pressing signal or the direction in which the sliding signal is moving.

According to the above method for switching between GUIs, the present invention further proposes an electronic device for switching GUIs, and this electronic device includes a touch screen and a processor. The touch screen displays a plurality of GUIs in a stack, and detects a pressing signal and a clicking/sliding signal. The processor determines if the pressing signal is on an overlapping area of the GUIs. If so, then the order of these windows are defined in an ordered list, and the topmost GUI is switched according to relative locations between the clicking/sliding signal and the pressing signal or the direction in which the sliding signal is moving.

Moreover, according to the above method for switching between GUIs. The present invention proposes a storage medium for storing a computer program. The computer program includes a plurality program codes for loading into an electronic device, such that the electronic device performs a method for switching between GUIs. This method for switching includes the following steps of: first, a plurality of GUIs is displayed in a stack on a touch screen. Then, when the touch screen detects a pressing signal on an overlapping area of these GUIs, and a clicking/sliding signal, the order of the GUIs are defined in an ordered list, and the topmost GUI is switched according to relative locations between the clicking/sliding signal and the pressing signal or the direction in which the sliding signal is moving.

When the clicking/sliding signal is at one of left and right sides of the pressing signal, it is determined that the topmost GUI is to be switched according to the ordered list in an ascending order. When the clicking/sliding signal is at the other one of the left and right sides of the pressing signal, it is determined that the topmost GUI is to be switched according to the ordered list in a descending order.

Alternatively, when the direction in which the sliding signal is moving is one of up and down, the topmost GUI is switched according to the ordered list in an ascending order. When the direction in which the sliding signal is moving is the other one of up and down, the topmost GUI is switched according to the ordered list in a descending order.

As described above, when a finger slides across the touch screen while another finger kept pressing on the overlapping area of the windows, the direction in which the sliding signal is sliding determines the windows are switched in the ascending or the descending order. For example, regardless of whether the sliding signal is at the right or left side of the pressing signal, as long as the direction of sliding is upwards, then switching is performed according to the ordered list in the ascending order. On the contrary, when the direction of sliding is downwards, then switching is performed according to the ordered list in the descending order.

In addition, the left and right sides can be determined through a so-called “Best Fitting Ellipse” method. When a finger touches the touch screen, an ellipse is generated on the screen, so the touch screen can determine the major axis and the minor axis in order to determine the direction of the ellipse (finger). After the direction of each finger is known, whether the position of the clicking finger is on the left or right side of a pressing finger can be determined based on the directions of the fingers.

In the case that the GUIs are to be switched according to the ordered list in the ascending order based on the relative positions between the clicking/sliding signal and the pressing signal, or based on the direction in which the sliding signal is moving, the topmost GUI is switched to the GUI following the original topmost GUI in the ordered list, that is, the GUI following the original topmost GUI in the ordered list is moved to the top layer. When the topmost GUI is switched to the GUI following the original topmost GUI in the ordered list, the original topmost GUI is moved to the bottommost layer.

In the case that the GUIs are to be switched according to the ordered list in the descending order based on the relative positions between the clicking/sliding signal and the pressing signal, or based on the direction in which the sliding signal is moving, the topmost GUI is switched to the GUI before the original topmost GUI in the ordered list, that is, the GUI before the original topmost GUI in the ordered list is moved to the top layer. When the topmost GUI is switched to the GUI before the original topmost GUI in the ordered list, the original topmost GUI is moved to the second layer.

In order to achieve the above switching, the present invention proposes an example. When switching in the ascending order is performed, i.e. each time a clicking/sliding action occurs at a side (one of left and right sides) of a pressing signal, or an action of sliding in a particular direction (one of up and down directions) occurs at an arbitrary side of a pressing signal, the topmost window is moved to the bottommost layer, while the rest of the windows are moved up one layer. For example, when a clicking/sliding action occurs once at a side of a pressing signal or one action of sliding in a particular direction occurs at an arbitrary side of a pressing signal, the original order of the windows from top to bottom W1, W2, W3 . . . Wn−2, Wn−1 and Wn becomes W2, W3, W4 . . . Wn−1, Wn and W1. Conversely, when switching in the descending order is performed, i.e. each time a clicking/sliding action occurs at the other side (the other one of left and right sides) of a pressing signal, or an action of sliding in the other direction (the other one of up and down directions) occurs at an arbitrary side of a pressing signal, the bottommost window is moved to topmost layer, while the rest of the windows are moved down one layer. For example, when a clicking/sliding action occurs once at the other side of a pressing signal or one action of sliding in the other direction occurs at an arbitrary side of a pressing signal, the original order of the windows from top to bottom W1, W2, W3 . . . Wn−2, Wn−1 and Wn becomes Wn, W1, W2 . . . Wn−3, Wn−2, and Wn−1.

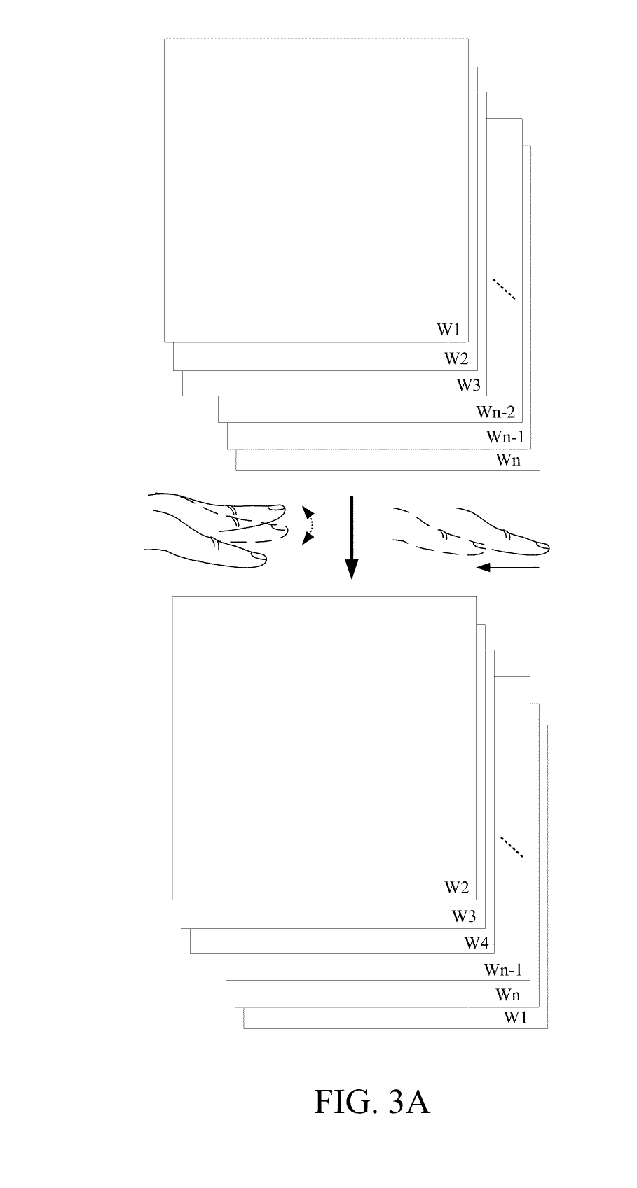

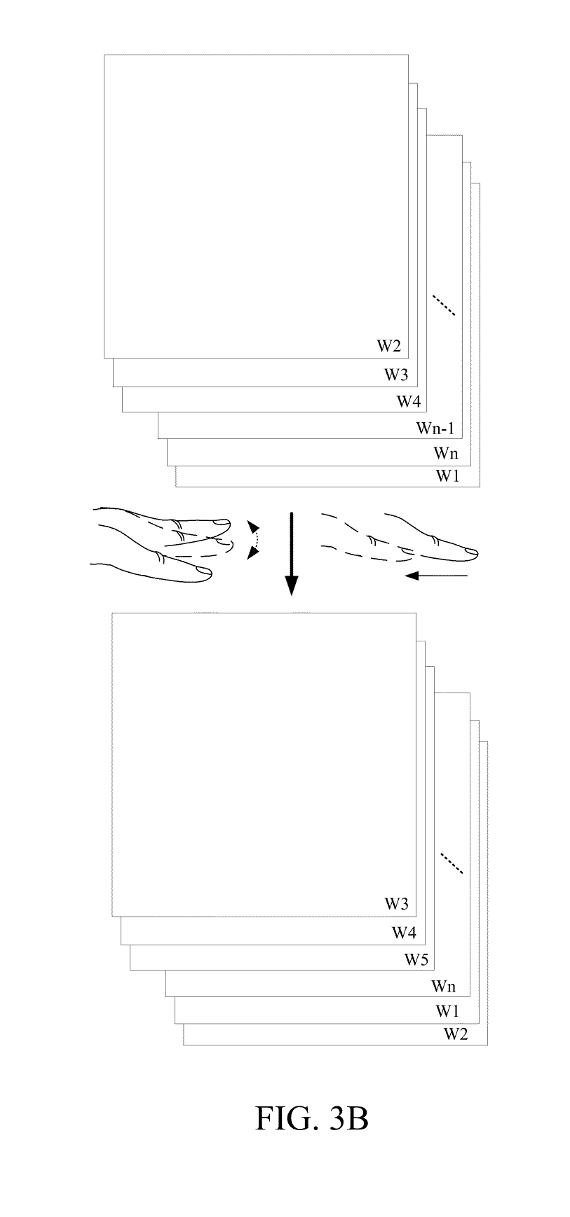

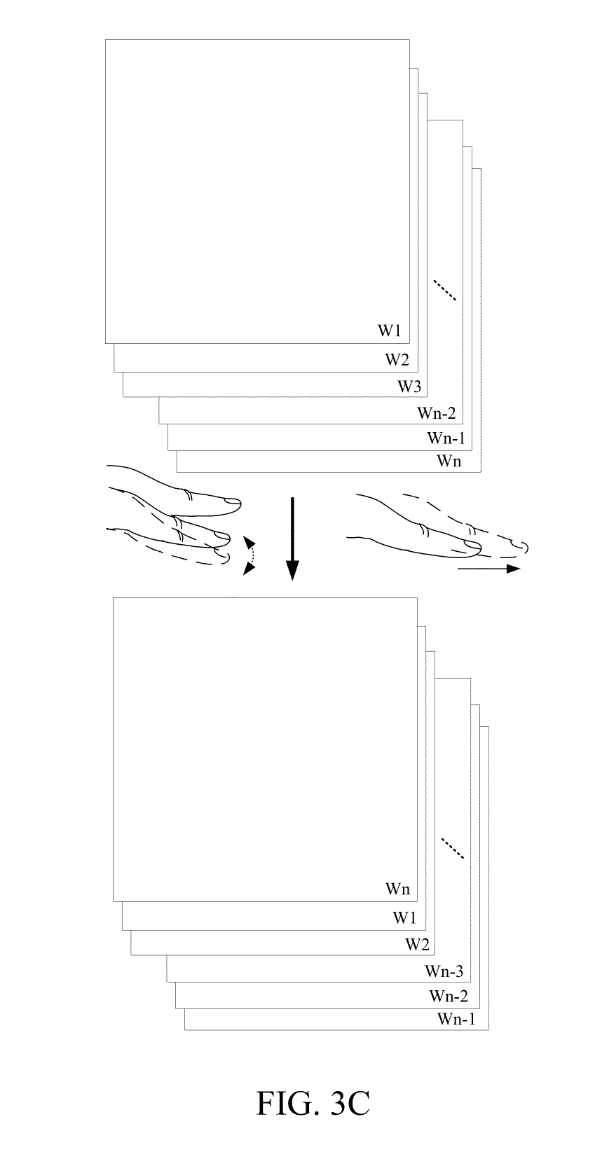

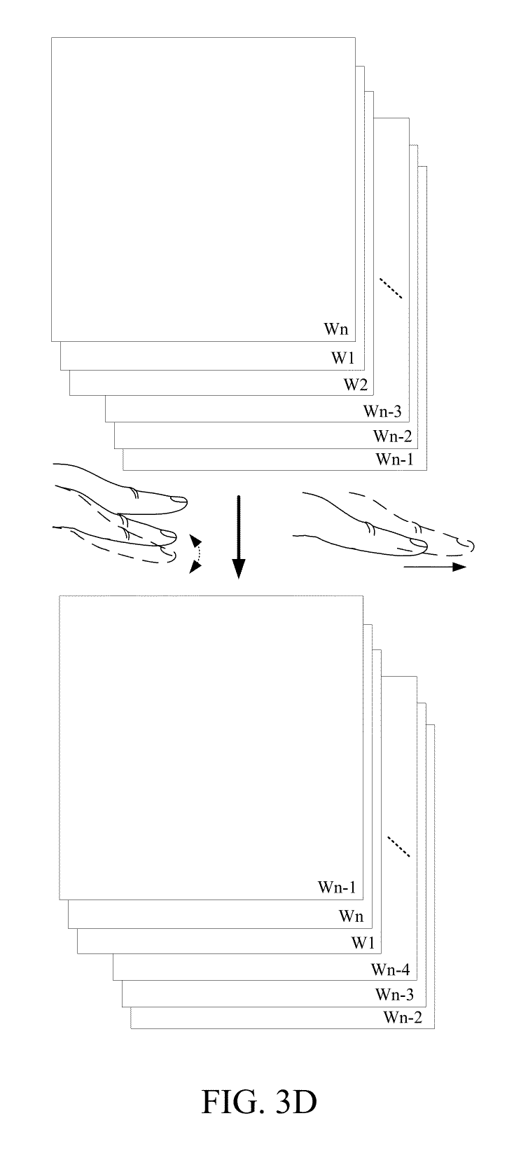

More particularly, when a clicking/sliding action occurs at the left side of a pressing signal or a downward sliding action occurs at an arbitrary side of a pressing signal and the current order of the windows from top to bottom is W1, W2, W3 . . . Wn−2, Wn−1 and Wn, each time a clicking/sliding action occurs at the left of the pressing signal, or a downward sliding action occurs at an arbitrary side of the pressing signal, the topmost window W1 (first in the ordered list) is moved to the bottommost layer, forming a new order of windows W2, W3, W4 . . . Wn−1, Wn and W1, as shown in FIG. 3A, now the window W2 is moved to the top layer to be displayed by the touch screen. Subsequently, if another clicking/sliding action occurs at the left side of the pressing signal, or a downward sliding action occurs at an arbitrary side of the pressing signal, the current topmost window W2 is moved to the bottommost layer, forming a new order of windows W3, W4, W5 . . . Wn, W1 and W2, as shown in FIG. 3B, now window W3 is moved to the top layer to be displayed on the touch screen.

Similarly, when a clicking/sliding action occurs at the right of a pressing signal or an upward sliding action occurs at an arbitrary side of a pressing signal, and the current order of the windows from top to bottom is W1, W2, W3 . . . Wn−2, Wn−1 and Wn, each time a clicking/sliding action occurs at the right of the pressing signal, or an upward sliding action occurs at an arbitrary side of the pressing signal, the bottommost window Wn is moved to the topmost layer, forming a new order of windows Wn, W1, W2 . . . Wn−3, Wn−2, and Wn−1, as shown in FIG. 3C, now the window Wn is moved to the top layer to be displayed by the touch screen. Of course, switching in the descending order can be defined as triggered when clicking/sliding occurs at the left of a pressing signal, or when a downward sliding action occurs at an arbitrary side of a pressing signal, while switching in the ascending order can be defined as triggered when clicking/sliding occurs at the right of a pressing signal, or when an upward sliding action occurs at an arbitrary side of a pressing signal.

Furthermore, the window switching mode can be one cycle or infinite cycles. Take switching in the ascending order as an example, after the touch screen has detected n−1 times of clicking/sliding signals, the original window order of W1, W2, W3 . . . Wn−2, Wn−1 and Wn is switched n−1 times according to the ordered list W1, W2, W3 . . . Wn−2, Wn−1 and Wn to arrive at a window order of Wn, W1, W2 . . . Wn−3, Wn−2 and Wn−1. If the window switching mode is defined to be one cycle, then at this time if another clicking/sliding signal corresponding to ascending switching is detected, the windows will not be switched, and the window order remains to be Wn, W1, W2 . . . Wn−3, Wn−2 and Wn−1, and window Wn is still at the topmost layer and displayed on the touch screen. However, descending switching can be carried out at this time. If the window switching mode is defined to be infinite cycles, then at this time if another clicking/sliding signal corresponding to ascending switching is detected, the topmost window Wn is moved to the bottom and window W1 is moved to the top to be displayed on the touch screen. Meanwhile, the window order is changed from Wn, W1, W2 . . . Wn−3, Wn−2 and Wn−1 back to the original window order of W1, W2, W3 . . . Wn−2, Wn−1 and Wn, and windows can be switched in infinite cycles.

Similarly, now take switching in the descending order as an example, after the touch screen has detected n−1 times of clicking/sliding signals, the original window order of W1, W2, W3 . . . Wn−2, Wn−1 and Wn is switched n−1 times according to the ordered list W1, W2, W3 . . . Wn−2, Wn−1 and Wn to arrive at a window order of W2, W3, W4 . . . Wn−1, Wn and W1. If the window switching mode is defined to be one cycle, then at this time if another clicking/sliding signal corresponding to descending switching is detected, the windows will not be switched, and the window order remains to be W2, W3, W4 . . . Wn−1, Wn and W1, and window W2 is still at the topmost layer and displayed on the touch screen. However, ascending switching can be carried out at this time. If the window switching mode is defined to be infinite cycles, then at this time if another clicking/sliding signal corresponding to descending switching is detected, the bottommost window W1 is moved to the top to be displayed on the touch screen. Meanwhile, the window order is changed from W2, W3, W4 . . . Wn−1, Wn and W1 back to the original window order of W1, W2, W3 . . . Wn−2, Wn−1 and Wn, and windows can be switched in infinite cycles.

Thus, when ascending switching is performed, in order to carry out infinite switching cycles, the GUI following the last in the ordered list can be defined as the first GUI in the new ordered list. Similarly, when descending switching is performed, in order to carry out infinite switching cycles, the GUI preceding the first in the ordered list can be defined as the last GUI in the ordered list.

In addition to the above methods, the topmost GUI can be defined as a reference GUI. When ascending switching is performed, the reference GUI is swapped with the GUI following the reference GUI in the original ordered list. When descending switching is performed, the reference GUI is swapped with the GUI preceding the reference GUI in the original ordered list.

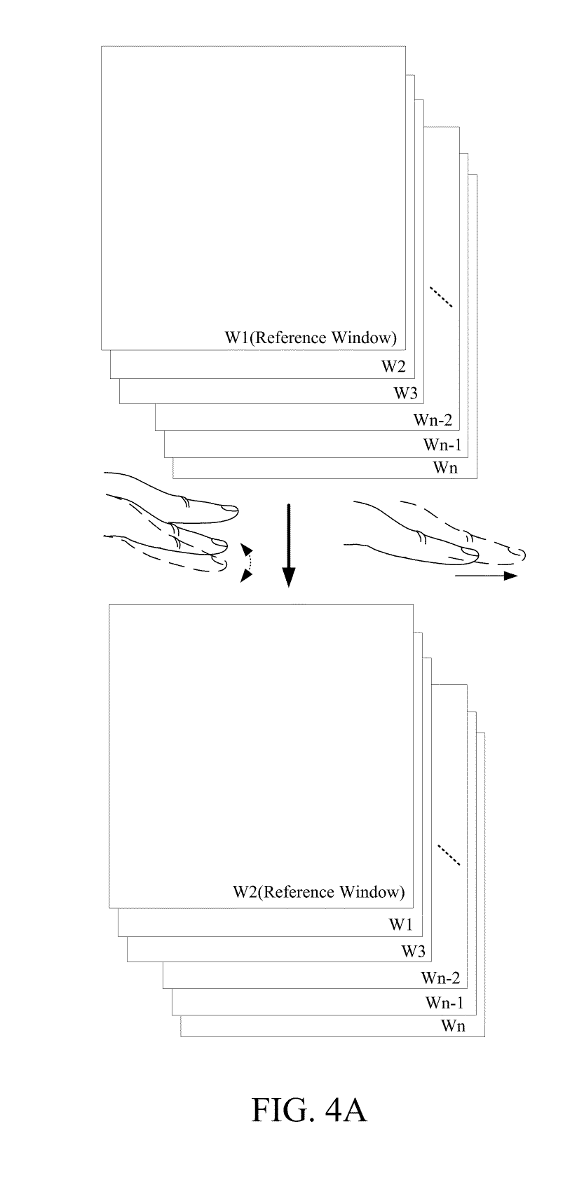

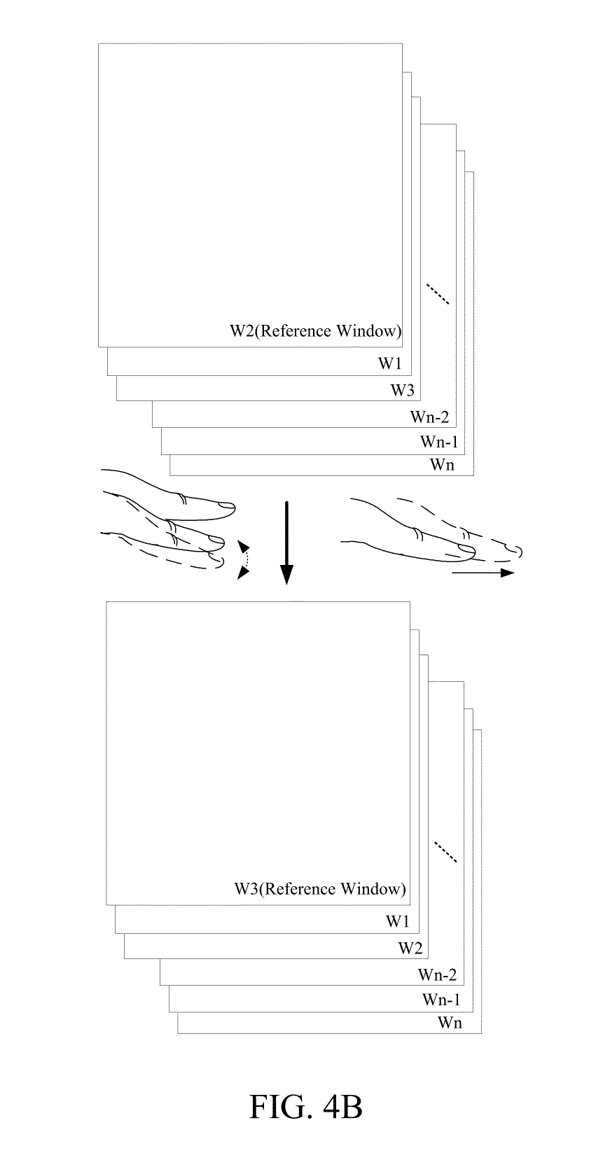

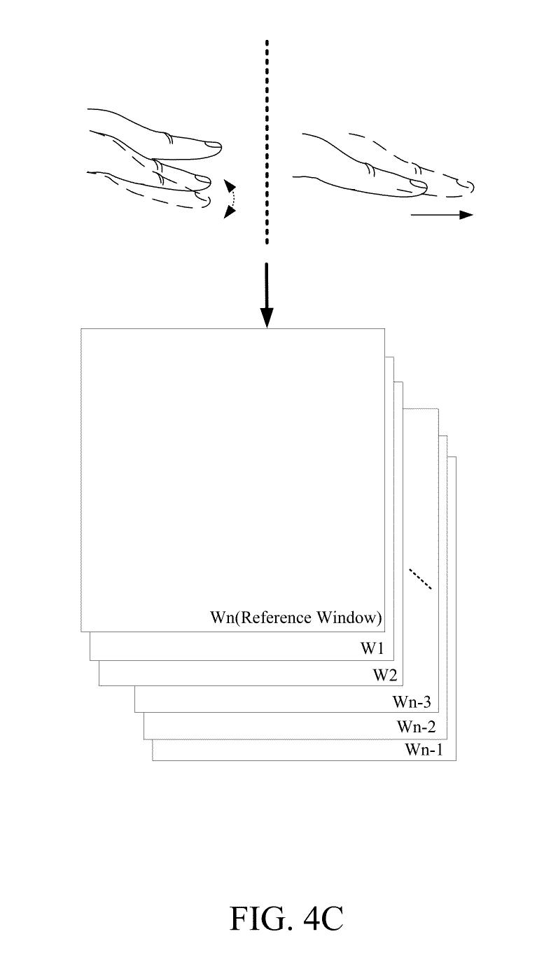

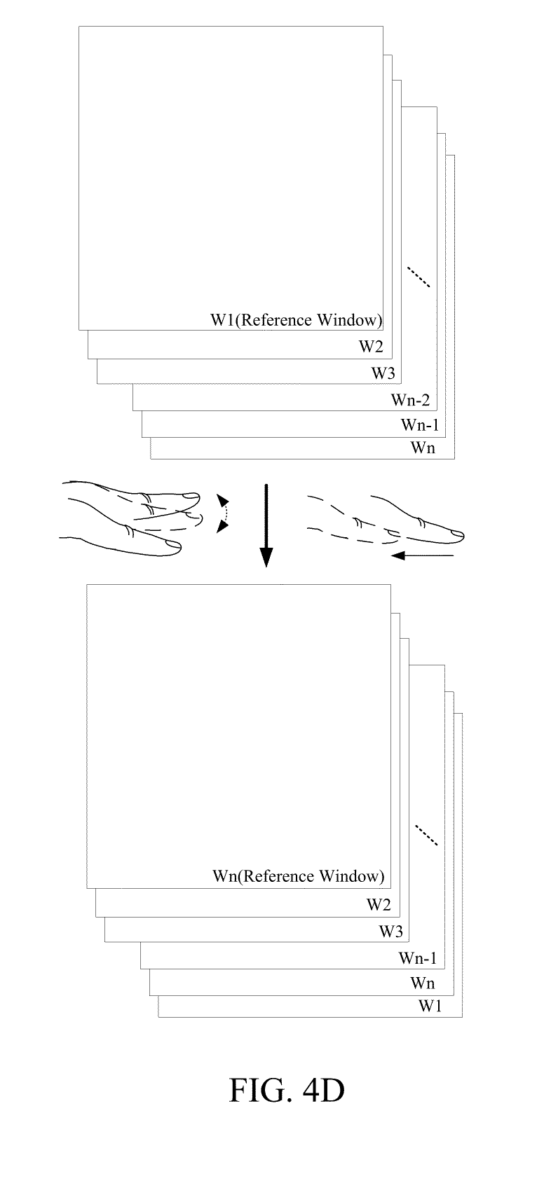

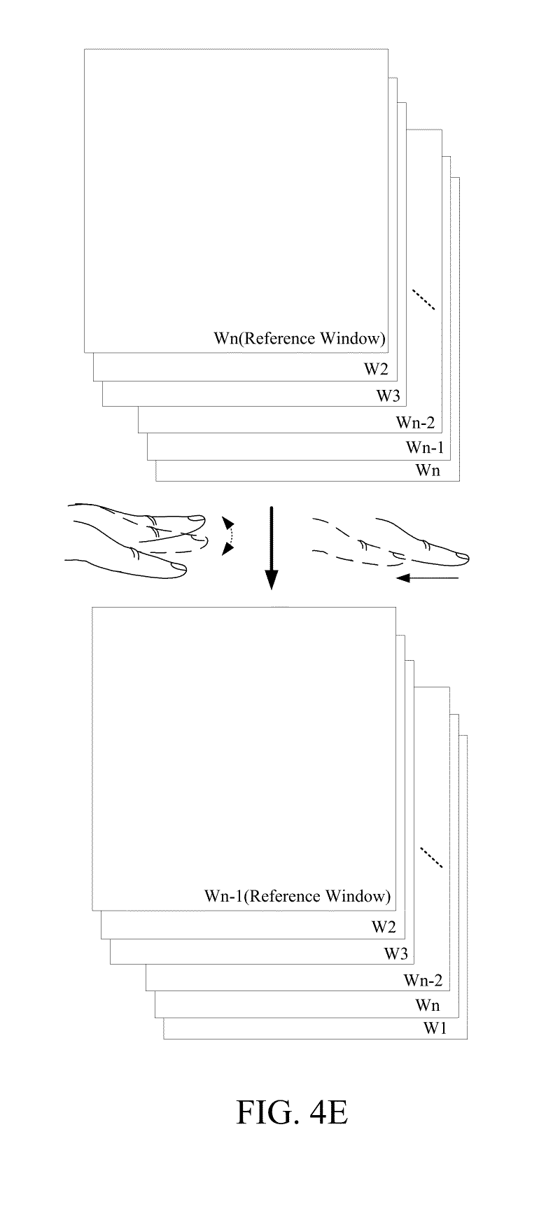

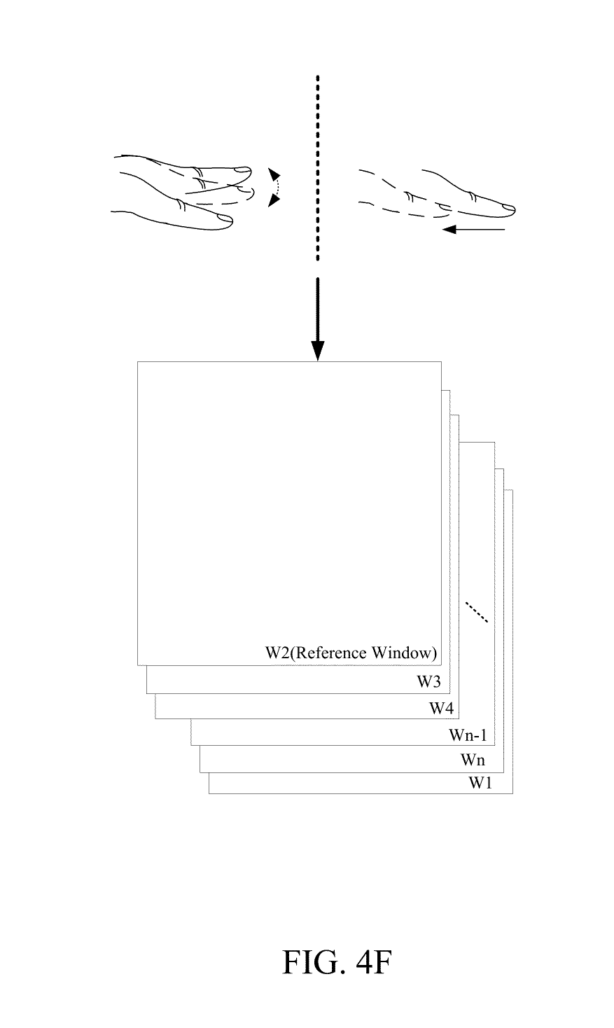

In order to perform the above switching, the present invention proposes another example as shown in the drawings. When the touch screen detects a pressing signal occurs at an overlapping area of the stacked windows and generates an ordered list, first the window displayed on the touch screen (the topmost window) is defined as the reference window (i.e. reference GUI). Then when ascending switching is performed, the reference GUI is swapped with the GUI following the reference GUI in the ordered list. More particularly, for example, when window W1 is displayed on the touch screen (at the topmost layer), then window W1 is the reference window. When performing ascending switching, window W1 (the reference window) is swapped with window W2 following window W1 in the ordered list of W1, W2, W3 . . . Wn−2, Wn−1 and Wn, as shown in FIG. 4A. Since now window W2 is displayed on the touch screen (at the topmost layer), the reference window is changed to window W2.

Subsequently, if ascending switching is performed again, window W2 is swapped with window W3 following the reference window (window W2) in the original ordered list of W1, W2, W3 . . . Wn−2, Wn−1 and Wn, forming a new window order of W3, W1, W2 . . . Wn−2, Wn−1, Wn, as shown in FIG. 4B. Accordingly, after n−1 times of ascending switching, a window order of Wn, W1, W2 . . . Wn−3, Wn−2 and Wn−1 is formed, as shown in FIG. 4C. If at this time another signal corresponding to ascending switching occurs, the window order Wn, W1, W2 . . . Wn−3, Wn−2 and Wn−1 remains the same as before (for one-cycle switching) or the window following window Wn in the ordered list of W1, W2, W3 . . . Wn−2, Wn−1 and Wn can be defined as window W1, enabling infinite ascending switching.

When descending switching is performed, the reference GUI is swapped with the GUI preceding the reference GUI in the ordered list. More particularly, for example, when window W1 is displayed on the touch screen (at the topmost layer), then window W1 is the reference window. When performing descending switching, window Wn is defined as the window preceding window W1 in the ordered list of W1, W2, W3 . . . Wn−2, Wn−1 and Wn, so at this time, window W1 is swapped with window Wn, forming a window order of Wn, W2, W3 . . . Wn−2, Wn−1 and W1, as shown in FIG. 4D. Since now window Wn is displayed on the touch screen (at the topmost layer), the reference window is changed to window Wn. Subsequently, if descending switching is performed again, window Wn is swapped with window Wn−1 preceding the reference window (window Wn) in the original ordered list of W1, W2, W3 . . . Wn−2, Wn−1 and Wn, forming a new window order of Wn−1, W2, W3 . . . Wn−2, Wn and W1, as shown in FIG. 4E. Accordingly, after n−1 times of descending switching, a window order of W2, W3, W4 . . . Wn−1, Wn and W1 is formed, as shown in FIG. 4F. If at this time another signal corresponding to ascending switching occurs, the window order W2, W3, W4 . . . Wn−1, Wn and W1 remains the same (for one-cycle switching) or the window order returns to the initial window order of W1, W2, W3 . . . Wn−2, Wn−1 and Wn, enabling infinite descending switching.

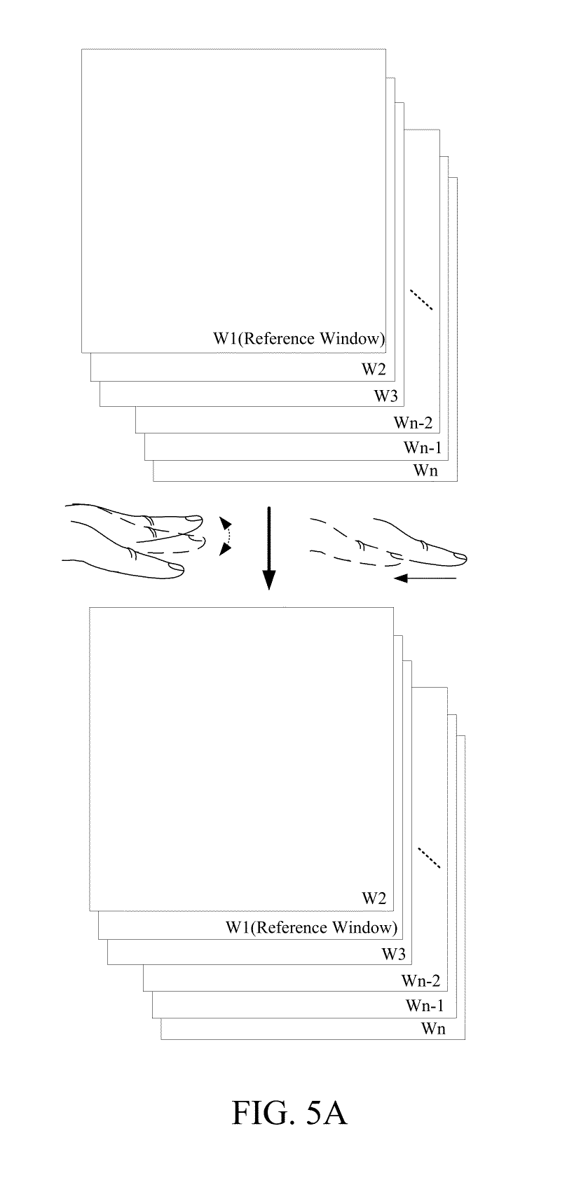

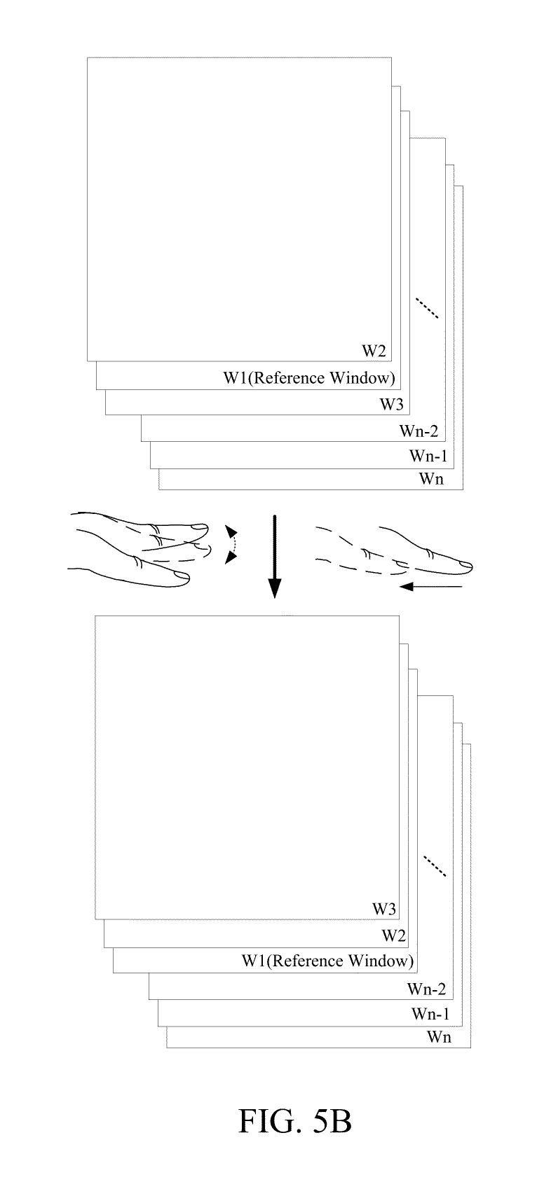

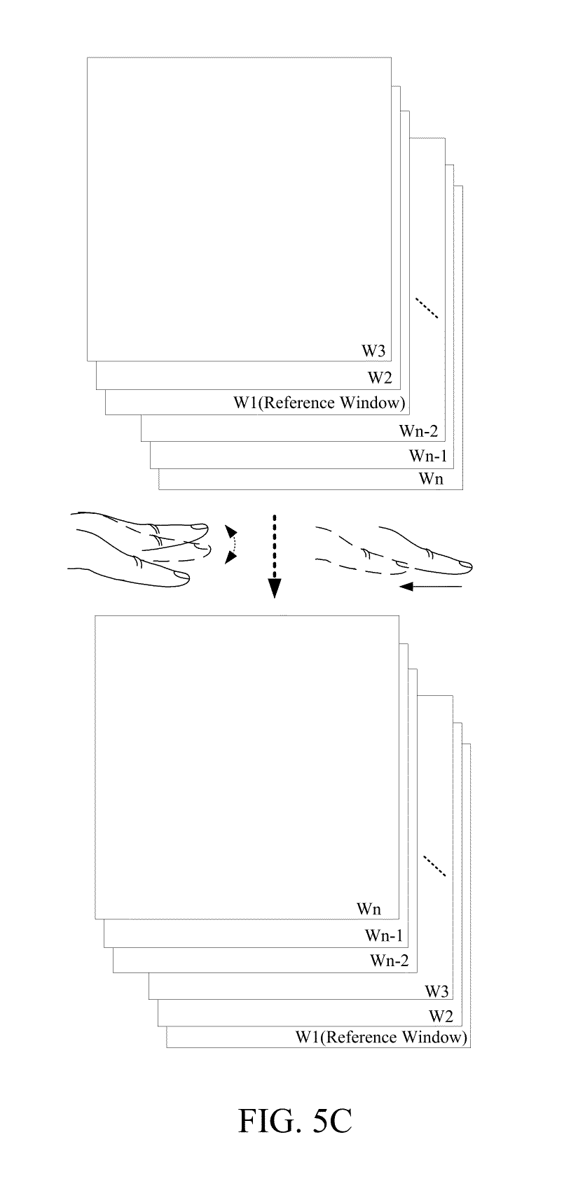

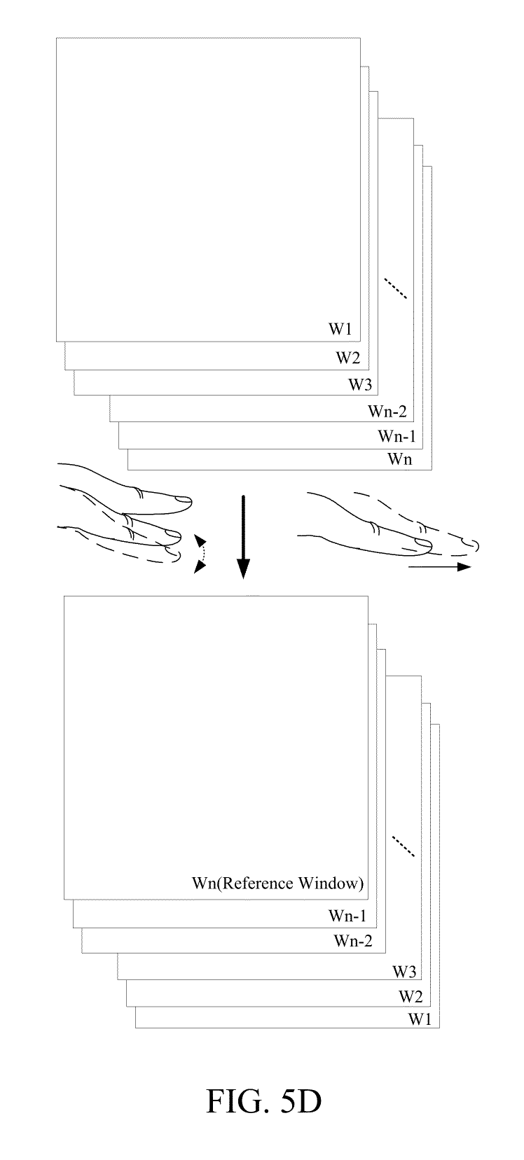

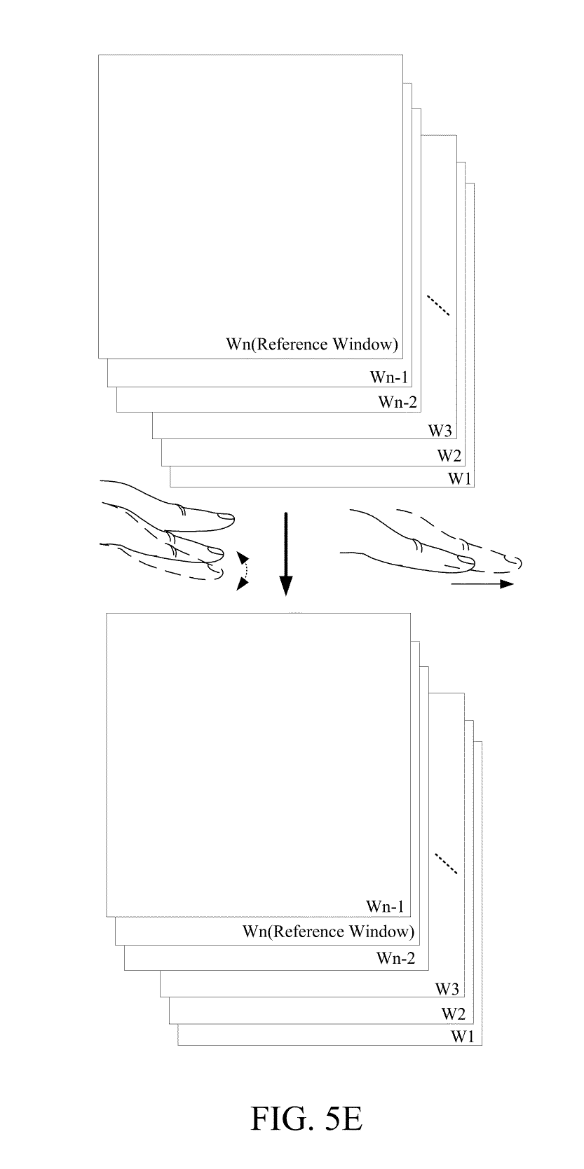

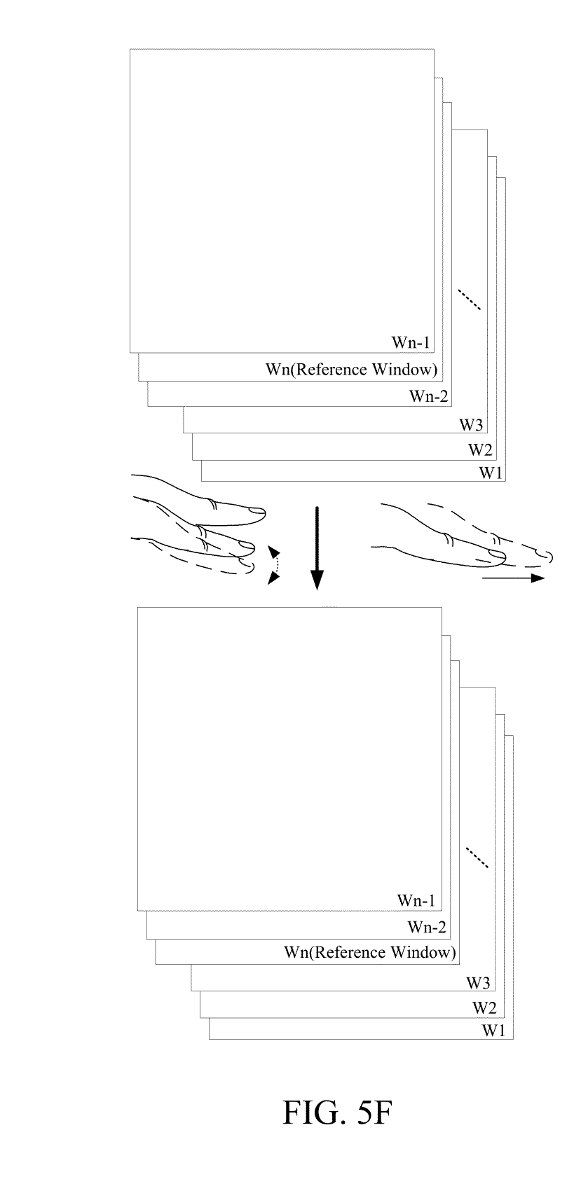

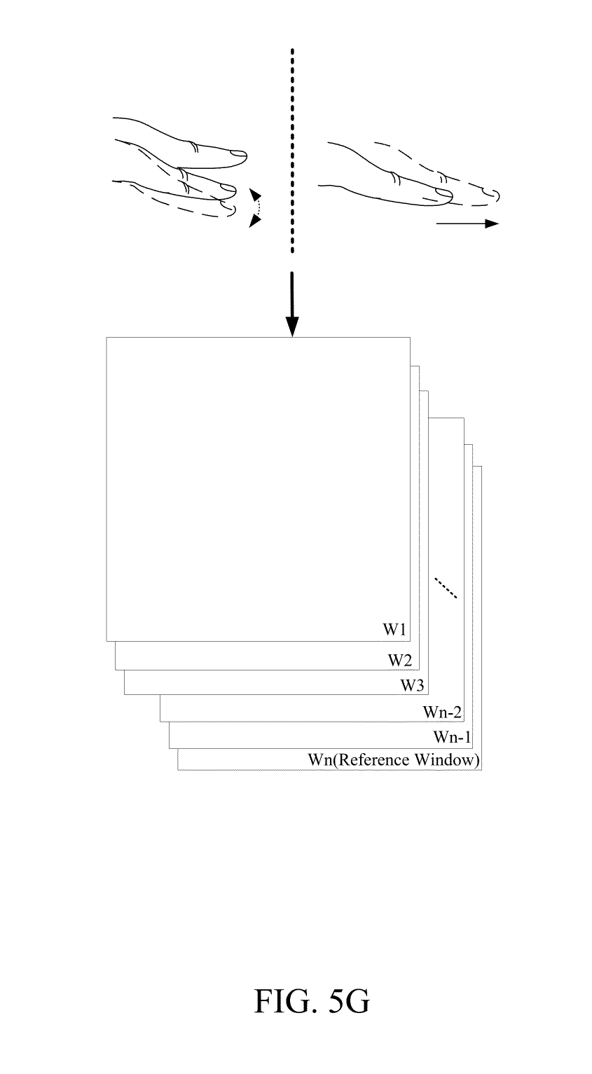

In order to achieve the above switching, the present invention proposes yet another example as shown in the drawings. When the touch screen detects a pressing signal occurs at an overlapping area of the stacked windows and a clicking signal corresponding to ascending switching is detected for the first time, the stacked windows from top to bottom are defined as the ordered list, and the topmost window in the ordered list is defined as the reference window. Subsequently, when the touch screen detects another clicking signal corresponding to ascending switching, the window below the reference window is moved to the top layer to be displayed on the touch screen. For example, when an ordered list of W1, W2, W3 . . . Wn−2, Wn−1 and Wn is generated, the topmost window W1 is defined as the reference window. When a clicking for ascending switching occurs, window W2 located below the reference window (window W2) is moved to the top layer, forming a new window order of W2, W1, W3 . . . Wn−2, Wn−1 and Wn, as shown in FIG. 5A. Subsequently, when another clicking for ascending switching occurs, window W3 located below the reference window (window W1) is moved to the top layer, forming a new window order of W3, W2, W1, . . . Wn−2, Wn−1 and Wn, as shown in FIG. 5B. Accordingly, with each subsequent clicking for ascending switching, window W4, window W5, window W6 . . . window Wn below the reference window (window W1) at the time is moved to the top layer, respectively, forming respective window orders of W4, W3, W2, . . . Wn−2, Wn−1 and Wn; W5, W4, W3, . . . Wn−2, Wn−1 and Wn; . . . ; and Wn, Wn−1, Wn−2 . . . W3, W2 and W1, as shown in FIG. 5C.

When ascending switching is performed repeated until a window order of Wn, Wn−1, Wn−2 . . . W3, W2 and W1 is formed, if at this time another clicking signal corresponding to ascending switching occurs, the window order of Wn, Wn−1, Wn−2 . . . W3, W2 and W1 remains unchanged (for one-cycle switching), or the window order can return to the initial window order of W1, W2, W3 . . . Wn−2, Wn−1 and Wn, enabling subsequent infinite window switching.

Conversely, when the touch screen detects a pressing signal occurs at an overlapping area of the stacked windows and a clicking signal corresponding to descending switching is detected for the first time, the stacked windows are first rearranged in the reverse order, and then the newly arranged stacked windows from top to bottom are defined as the ordered list, and the topmost window in the ordered list is defined as the reference window. Subsequently, when the touch screen detects another clicking signal corresponding to descending switching, the window below the reference window is moved to the top layer to be displayed on the touch screen.

For example, when the touch screen detects a clicking signal corresponding to descending switching is detected for the first time, the order of the stacked windows W1, W2, W3 . . . Wn−2, Wn−1 and Wn is first rearranged in the reverse order to a new order of Wn, Wn−1, Wn−2 . . . W3, W2 and W1, as shown in FIG. 5D. At this time, the topmost window Wn is defined as the reference window. Subsequently, when the touch screen detects another clicking signal corresponding to descending switching, window Wn−1 below the reference window (window Wn) is moved to the top layer, and so the window order becomes Wn−1, Wn, Wn−2 . . . W3, W2 and W1, as shown in FIG. 5E. Subsequently, when the touch screen detects yet another clicking signal corresponding to descending switching, window Wn−2 below the reference window (window Wn) is moved to the top layer, and so the window order becomes Wn−2, Wn−1, Wn . . . W3, W2 and W1, as shown in FIG. 5F. Accordingly, with each subsequent clicking for descending switching, window Wn−3, window Wn−4, window Wn−5 . . . window W1 below the reference window (window Wn) at the time is moved to the top layer, respectively, forming respective window orders of Wn−3, Wn−2, Wn−1 . . . W3, W2 and W1; Wn−4, Wn−3, Wn−2 . . . W3, W2 and W1; . . . ; and W1, W2, W3 . . . Wn−2, Wn−1 and Wn, as shown in FIG. 5G.

When descending switching is performed repeated until a window order of W1, W2, W3 . . . Wn−2, Wn−1 and Wn is formed, if at this time another clicking signal corresponding to descending switching occurs, the window order of W1, W2, W3 . . . Wn−2, Wn−1 and Wn may remain unchanged (for one-cycle switching), or the window order can rearranged in the reverse order again to become the initial window order of Wn, Wn−1, Wn−2 . . . W3, W2 and W1, enabling subsequent infinite descending window switching.

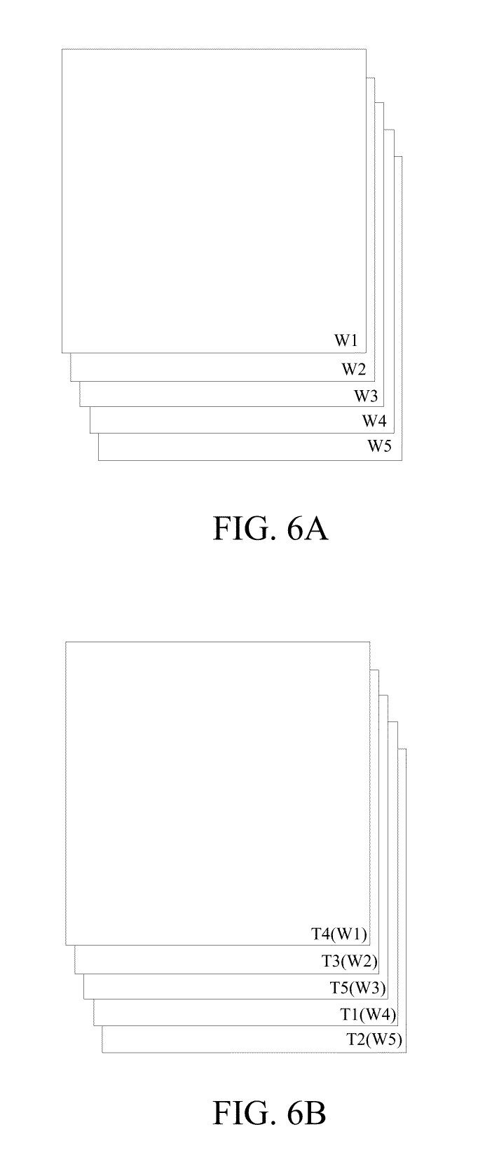

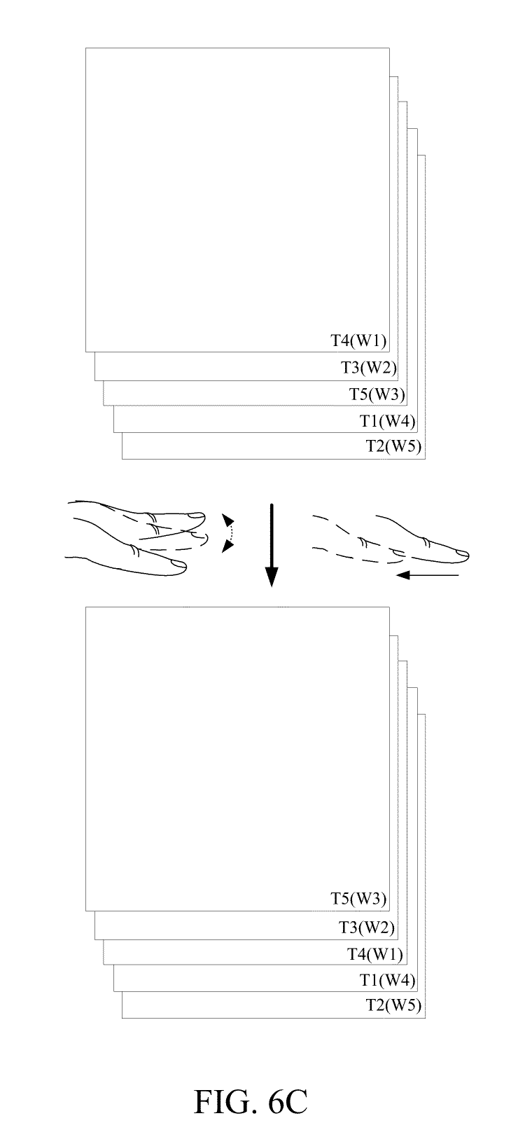

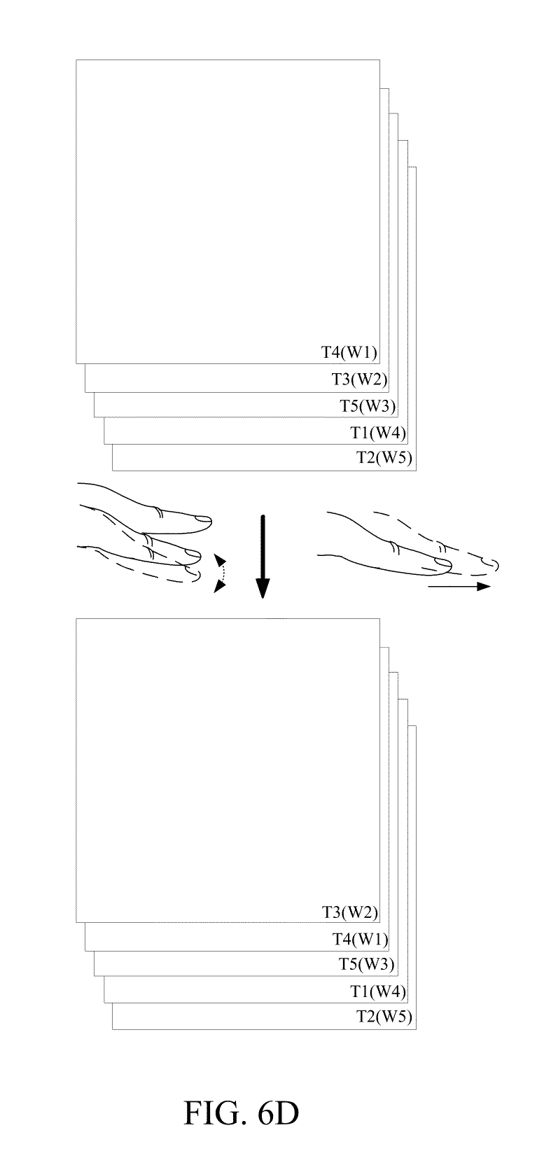

In addition to defining the ordered list by the order of the windows in space, it can also be defined by the order of the windows in time. If the ordered list is defined according to the stacking relationships of the windows in space, as shown in the drawings, when a pressing signal occurs at the overlapping area of the stacked windows, the order from the top GUI down to the bottom GUI is defined as the ordered list W1, W2, W3, W4 and W5 as shown in FIG. 6A. However, if the stacked windows are ordered according to when the windows are launched, then the order becomes window W4, window W5, window W2, window W1 and window W3. Thus, if the ordered list is defined according to when the windows are launched, when a pressing signal occurs at the overlapping area of the stacked windows, the order from the GUI that was opened earliest to the GUI that was opened the last is defined as the ordered list: T1(W4), T2(W5), T3(W2), T4(W1) and T5(W3), as shown in FIG. 6B.

Since the current stacking relationships of the windows from top to bottom in space is T4(W1), T3(W2), T5(W3), T1(W4) and T2(W5), and the topmost window is window T4. When the ordered list defined according to when the windows are opened is T1, T2, T3, T4 and T5, and ascending switching is performed based on this, then the topmost window upon ascending switching will change from window T4(W1) to T5(W3), as shown in FIG. 6C. In other words, this is equivalent to switching window W1 at the topmost layer to window W3 at the third layer in space.

When performing descending switching, the same applies. Window T4(W1) is switched to window T3(W2), which is equivalent to switching window W1 at the topmost layer to window W2 at the second layer in space, as shown in FIG. 6D. Switching modes can be implemented like those described in the previous examples. Furthermore, the number of windows above is for illustrative purpose only; the present invention is not limited to this.

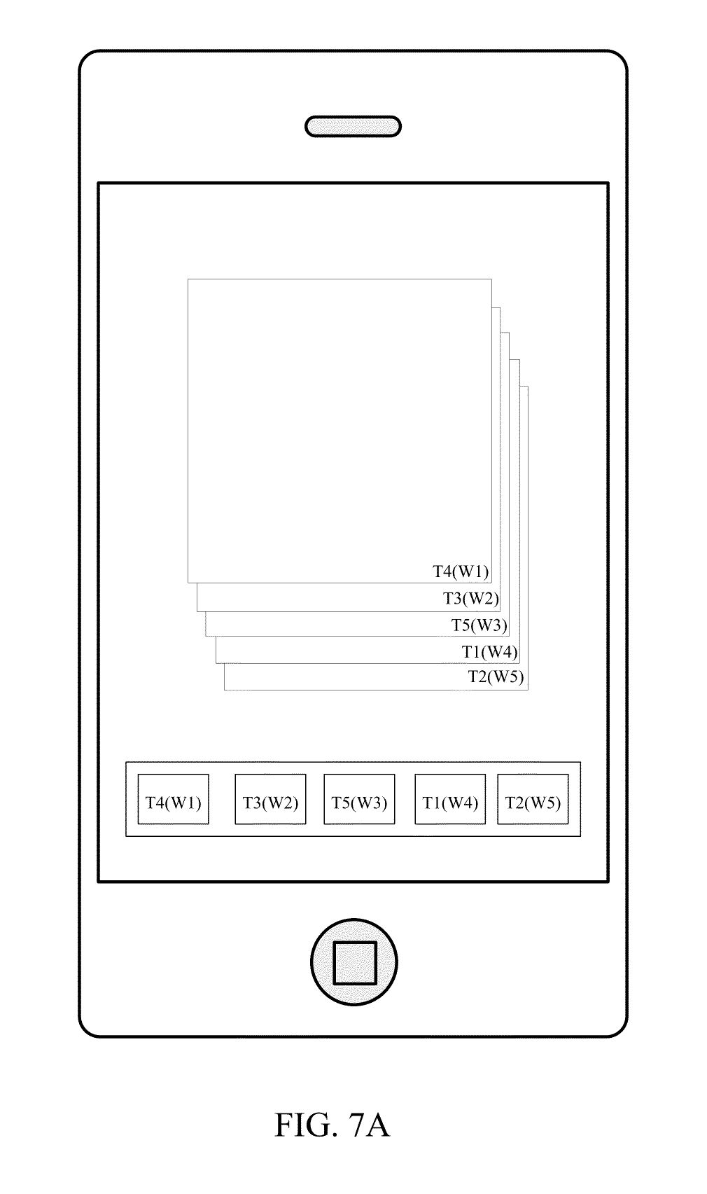

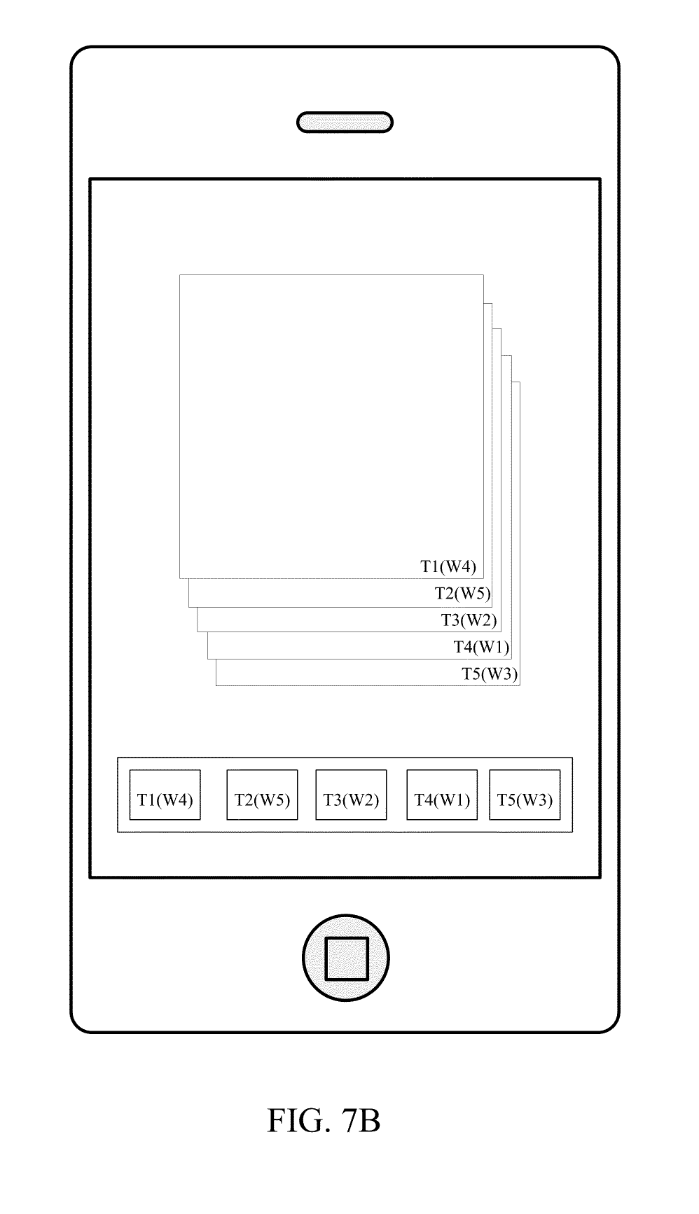

In order to more clearly display the switching status of the GUIs, the above touch screen can further display an array of representative icons, and this array includes representative icons corresponding to each currently opened GUIs. When the topmost GUI is switched, the order of the representative icons representing each GUI is also switched. The array of representative icons can be ordered from the topmost GUI to the bottommost GUI in space, as shown in FIG. 7A, or from the GUI that was opened earliest to the GUI that was opened last in time, as shown in FIG. 7B.

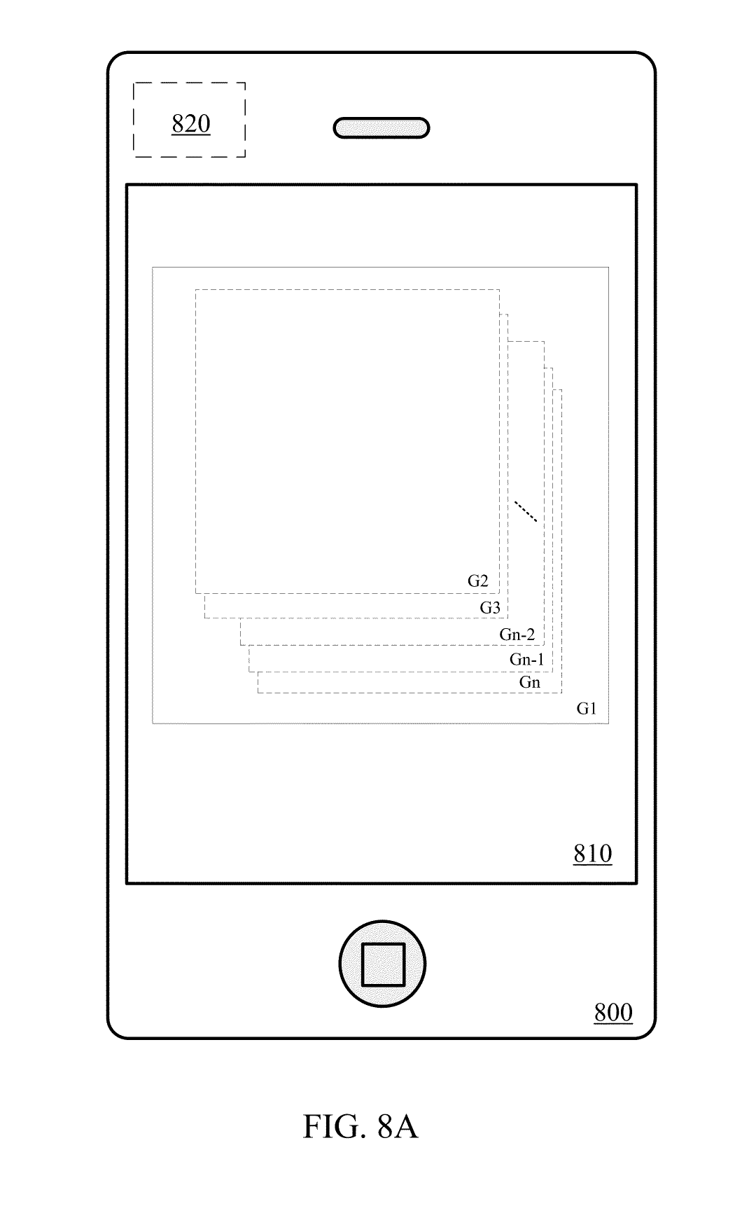

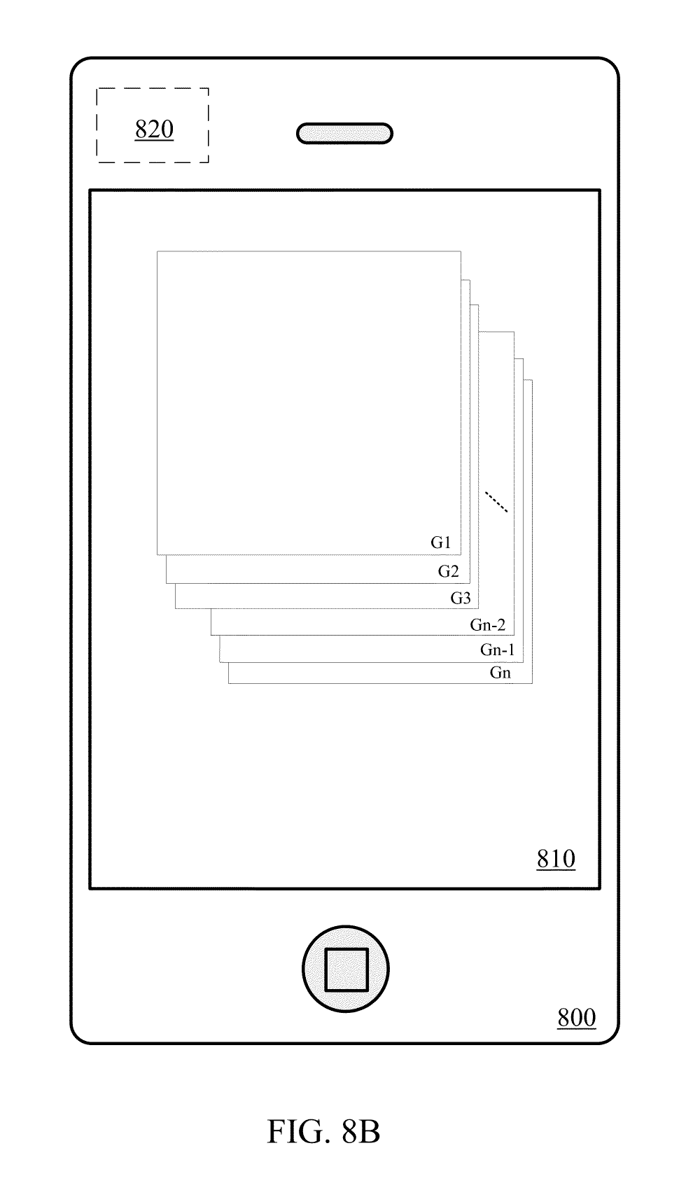

In addition to the above methods for switching and switching devices, the present invention further provides an electronic device 800 for displaying GUIs, as shown in FIGS. 8A and 8B. This device includes a touch screen 810 and a processor 820. The touch screen 810 displays one (as shown in FIG. 8A) or several (as shown in FIG. 8B) of a plurality of GUIs G1, G2, G3 . . . Gn−2, Gn−1 and Gn stacked together, and detects a first touch signal and a second touch signal. As shown in FIG. 8A, a plurality of GUIs are shown to be stacked together on the touch screen, the topmost GUI completely covers the rest of the GUIs, so the touch screen only displays the topmost GUI. Alternatively, as shown in FIG. 8B, the topmost GUI only partially covers the rest of the GUIs, so the touch screen displays not only the topmost GUI, but also the portions of the rest of the GUIs that are not covered.

These GUIs are arranged in a sequential order, and this sequential order defines the GUI(s) preceding and/or following the topmost GUI. For example, these GUIs are stacked from the topmost layer to the bottommost layer based on the sequential order of G1, G2, G3 . . . Gn−2, Gn−1 and Gn, and the GUI preceding or following the topmost GUI G1 is defined as Gn, or the GUI preceding or following the topmost GUI G1 is defined as G2. Of course, the GUI preceding GUI G1 can be defined as GUI Gn, while the GUI following GUI G1 can be defined as GUI G2, or the GUI preceding GUI G1 can be defined as GUI G2, while the GUI following GUI G1 can be defined as GUI Gn. These are only for illustrative purpose, and the preceding/following GUIs do not have to be limited to Gn or G2.

The processor 820 determines if the first touch signal occurs at the overlapping area of these GUIs, and when it determines that the second touch signal occurs while the first touch signal continuously exists in the overlapping area of the GUIs, then the relative locations between the first and second touch signals or the direction in which the second touch signal is moving is determined, and the topmost GUI is switched accordingly. The touch screen 810 can be composed of a touch panel and a display, which can be integrated by add-on or combined together in the manufacturing process of the display, forming such as an “on-cell” touch screen or “in-cell” touch screen.

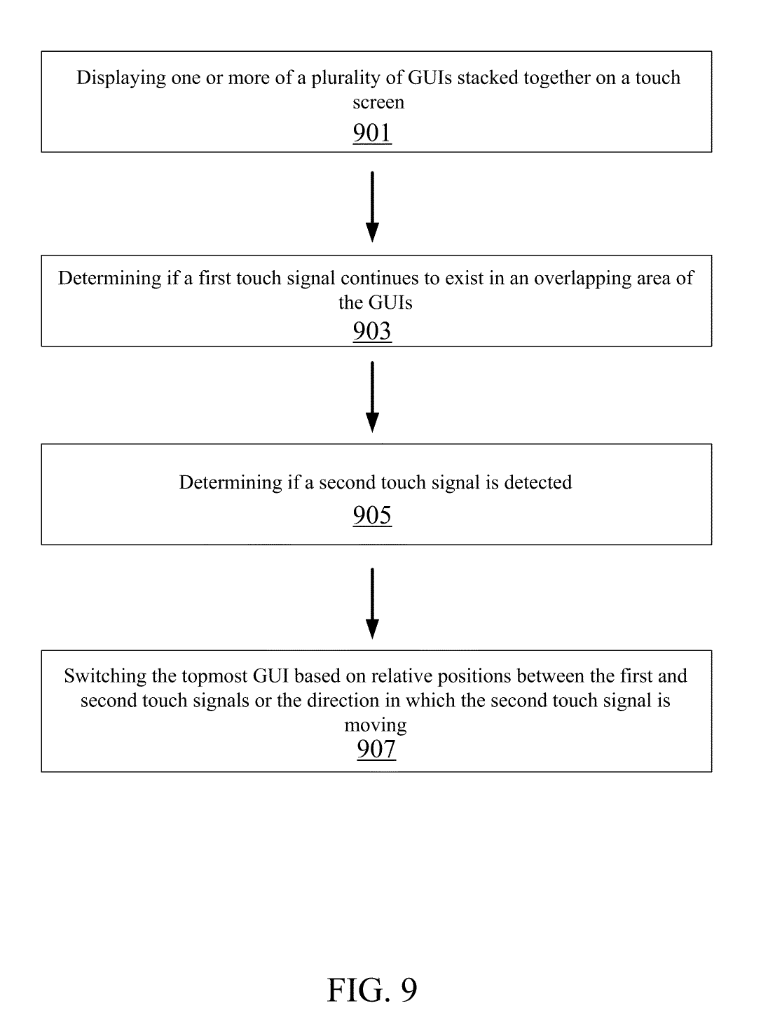

Therefore, the present invention also provides a method for displaying GUIs. As shown in FIG. 9, the method includes the following steps. First, in step 901, one or more of a plurality of GUIs stacked together are displayed on a touch screen. These GUIs are arranged in a sequential order, which defines GUI(s) preceding and/or following a GUI at the topmost layer.

Subsequently, when the touch screen detects a second touch signal while a first touch signal continuously exists in the overlapping area of the GUIs, the topmost GUI is switched according to the relative locations between the first and second touch signals or the direction in which the second touch signal is moving. For example, when a finger is continuously pressing on the overlapping area of the GUIs, that is, the first touch signal continues to exist, the touch screen detects clicking by another finger (the second touch signal), the topmost GUI is switched according to the relative locations between the first and second touch signals or the direction in which the second touch signal is moving, wherein the switching of the topmost GUI is performed when the second touch signal appears or disappears. For example, as soon as another finger touches the touch screen, the GUI is immediately switched, or after another finger has clicked on and then left the touch screen, the GUI is then switched. Other relevant details are the same as those described before, and will not be unnecessarily repeated.

Thus, in step 903, whether a first signal continues to exist in the overlapping area of the GUIs is determined. If so, then in step 905, whether a second touch signal is detected by the touch screen is determined. If not, then proceed to step 903. When the touch screen detects the second touch signal, then in step 907, the topmost GUI is switched according to the relative relationships between the first and the second touch signals, or the direction in which the second touch signal is moving; else, step 905 is repeated.

According to the above, the present invention further provides a storage medium for storing a computer program. The computer program includes a plurality of program codes for loading into an electronic device and enables the electronic device to perform a method for display GUIs including the following steps. First, one or more of a plurality of GUIs stacked together are displayed on a touch screen, wherein these GUIs are arranged in a sequential order, which defines GUI(s) preceding and/or following a GUI at the topmost layer. Subsequently, when a second touch signal is detected by the touch screen while a first touch signal continues to exist in the overlapping area of the GUIs, the topmost GUI is switched according to the relative locations between the first and second touch signals or the direction in which the second touch signal is moving.

According to the above technique, the present invention also provides another method for displaying GUIs including the following steps. First, one of a plurality of GUIs stacked together are displayed on a touch screen, wherein the topmost GUI completely covers the rest of the GUIs. These GUIs are arranged in a sequential order, which defines GUI(s) preceding and/or following a GUI that is currently being displayed.

The above sequential order can be divided into a cyclic queue and a non-cyclic queue. Take the cyclic queue as an example, each GUI has a preceding GUI and a following GUI. When the GUIs are arranged in a sequential order of G1, G2, G3 . . . Gn−2, Gn−1 and Gn, and the GUI currently displayed by the touch screen is G1, the GUI preceding GUI G1 can be defined as Gn, and also the GUI following GUI G1 can be defined as G2. When the GUI currently displayed by the touch screen is Gn, the GUI preceding GUI Gn can be defined as Gn−1, and also the GUI following GUI Gn can be defined as G1.

For a non-cyclic queue, the first GUI in the sequential order does not have a preceding GUI, and the last GUI in the sequential order does not have a following GUI. When the GUI currently displayed by the touch screen is G1, the GUI following GUI G1 can be defined as G2, but the GUI preceding GUI G1 cannot be defined. When the GUI currently displayed by the touch screen is Gn, the GUI preceding GUI Gn can be defined as Gn−1, but the GUI following GUI Gn cannot be defined.

Subsequently, when pressing, lifting, sliding or sliding in the air of a second external object is detected by the touch screen while a first external object is pressing in the overlapping area of the GUIs, and the currently displayed GUI has a following GUI, the GUI following the currently displayed GUI is then displayed. For example, if the currently displayed GUI is G1, then GUI G1 has a following GUI G2. In this case, if pressing, lifting, sliding or sliding in the air of a second finger (second external object) is detected by the touch screen while a first finger (first external object) is pressing in the overlapping area of the GUIs, then the currently displayed GUI G1 is switched to the following GUI G2. When the currently displayed GUI is Gn, since GUI Gn does not have a following GUI, if at this time pressing, lifting, sliding or sliding in the air of a second finger is detected by the touch screen while a first finger is pressing in the overlapping area of the GUIs, then GUI Gn remains to be displayed without any switching.

The above method for displaying GUIs further includes the following steps. When pressing, lifting, sliding or sliding in the air of a first external object is detected by the touch screen while a second external object is pressing in the overlapping area of the GUIs, and the currently displayed GUI has a preceding GUI, the GUI preceding the currently displayed GUI is then displayed. For example, if the currently displayed GUI G1 has a preceding GUI Gn. In this case, if pressing, lifting, sliding or sliding in the air of a first finger is detected by the touch screen while a second finger is pressing in the overlapping area of the GUIs, then the currently displayed GUI G1 is switched to the preceding GUI Gn. Conversely, if the currently displayed GUI G1 does not have a preceding GUI, if pressing, lifting, sliding or sliding in the air of a first finger is detected by the touch screen while a second finger is pressing in the overlapping area of the GUIs, then GUI G1 remains to be displayed on the touch screen without any switching.

The above first external object is at a first side of the second external object, and the second external object is at a second side of the first external object, wherein the first and second sides are opposite sides. For example, the first finger is a left finger, and the second finger is a right finger, then the left finger is at the left (first side) of the right finger, and the right finger is at the right (second side) of the left finger; obviously, left and right sides are opposite sides.

Furthermore, the durations in which the first and second external objects are pressing can be partially or completely overlapped. For example, during the time the left finger is pressing down, if the right finger clicks once (press and then lift), it will cause the touch screen to display the GUI following the currently displayed GUI, in other words, the durations in which the first and second external objects are pressing are completely overlapped, or the two fingers simultaneously presses down, and then the left finger remains pressing down whereas the right finger lifts up, this also means the durations in which the first and second external objects are pressing are completely overlapped. Alternatively, when the left finger is pressing down, the right finger then presses down and remains pressing down, and at this time, the left finger lifts up, this will cause the touch screen to display the GUI preceding the currently displayed GUI, in other words, the durations in which the first and second external objects are pressing are partially overlapped.

In addition, the durations in which the first and second external objects are pressing can be not overlapped at all. For example, after the left finger presses down and lifts up, the right finger then clicks once, causing the touch screen to display the GUI following the currently displayed GUI.

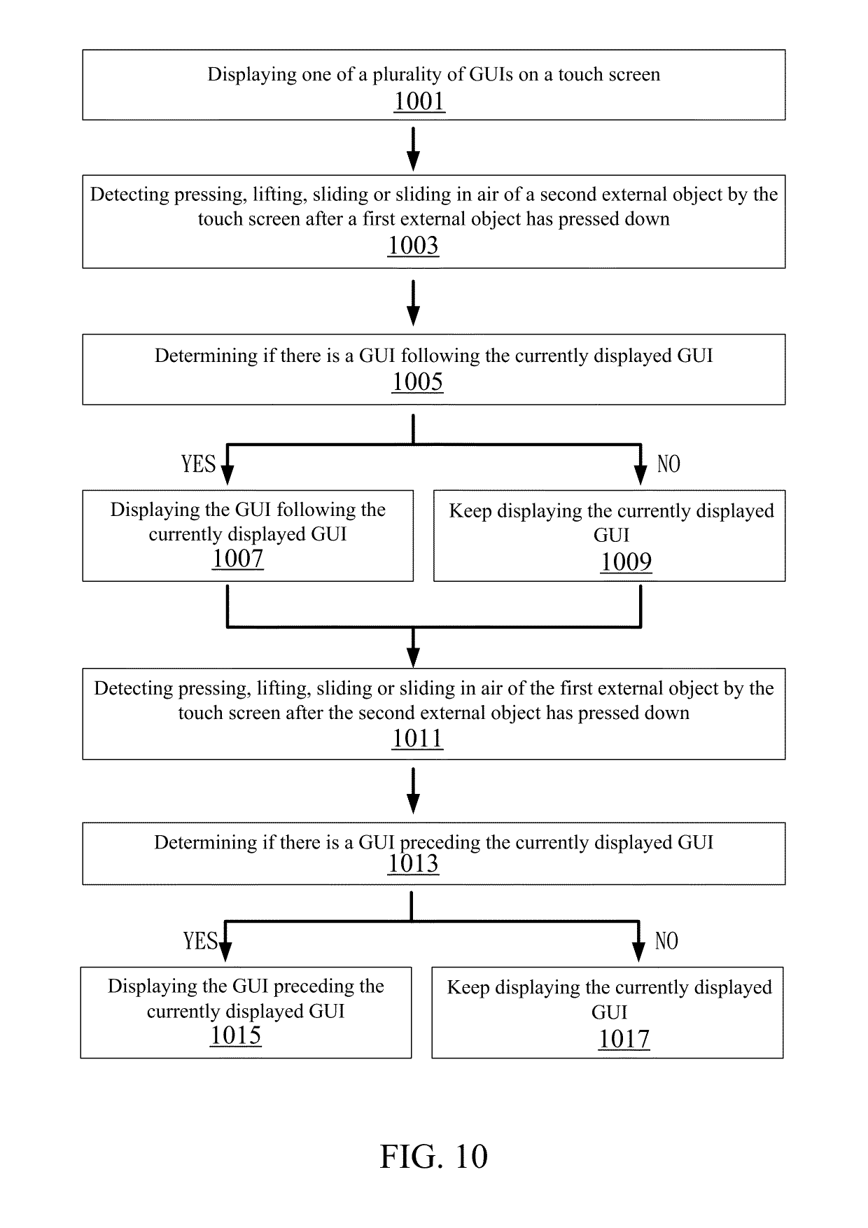

Thus, the present invention performs the following steps according to the above method, as shown in FIG. 10. In step 1001, one of a plurality of GUIs is displayed on a touch screen. In step 1003, pressing, lifting, sliding or sliding in air of a second external object after a first external object has pressed down is detected by the touch screen. In step 1005, it is determined if there is a GUI following the currently displayed GUI. If so, then in step 1007, the GUI following the currently displayed GUI is displayed. If not, then in step 1009, the GUI that is currently being displayed is still displayed.

After step 1007 or 1009, in step 1011, pressing, lifting, sliding or sliding in air of the first external object after the second external object has pressed down is detected by the touch screen. In step 1013, it is determined if there is a GUI preceding the currently displayed GUI. If so, then in step 1015, the GUI preceding the currently displayed GUI is displayed. If not, then in step 1017, the GUI that is currently being displayed is still displayed.

Accordingly, the present invention proposes a display device 800 for GUIs, which includes a touch screen 810 and a processor 820, as shown in FIG. 8A. The touch screen 810 displays one of a plurality of GUIs G1, G2, G3 . . . Gn−2, Gn−1 and Gn, the GUIs are arranged in a sequential order, which defines a GUI preceding and/or a GUI following the currently displayed GUI. The processor 820 detects pressing, lifting, sliding or sliding in air of a second external object after a first external object has pressed down, and if there is a GUI following the currently displayed GUI, then the GUI following the currently displayed GUI is displayed on the touch screen 810. The processor 820 further detects pressing, lifting, sliding or sliding in air of the first external object after the second external object has pressed down, and if there is a GUI preceding the currently displayed GUI, then the GUI preceding the currently displayed GUI is displayed on the touch screen 810, wherein the first external object is at a first side of the second external object, and the second external object is at a second side of the first external object, wherein the first and second sides are opposite sides.

Similarly, the present invention further proposes a method for displaying GUIs, which includes the following steps. First, one of a plurality of GUIs is displayed by a touch screen, and the GUIs are arranged in a sequential order, which defines a GUI preceding and/or a GUI following the currently displayed GUI. Then, sliding forward or sliding forward in air of a second external object after a first external object has pressed down is detected by the touch screen, and if there is a GUI preceding the currently displayed GUI, then the GUI preceding the currently displayed GUI is displayed on the touch screen.

This method further includes the following steps. Sliding backward or sliding backward in air of the second external object after the first external object has pressed down is detected by the touch screen, and if there is a GUI following the currently displayed GUI, then the GUI following the currently displayed GUI is displayed on the touch screen.

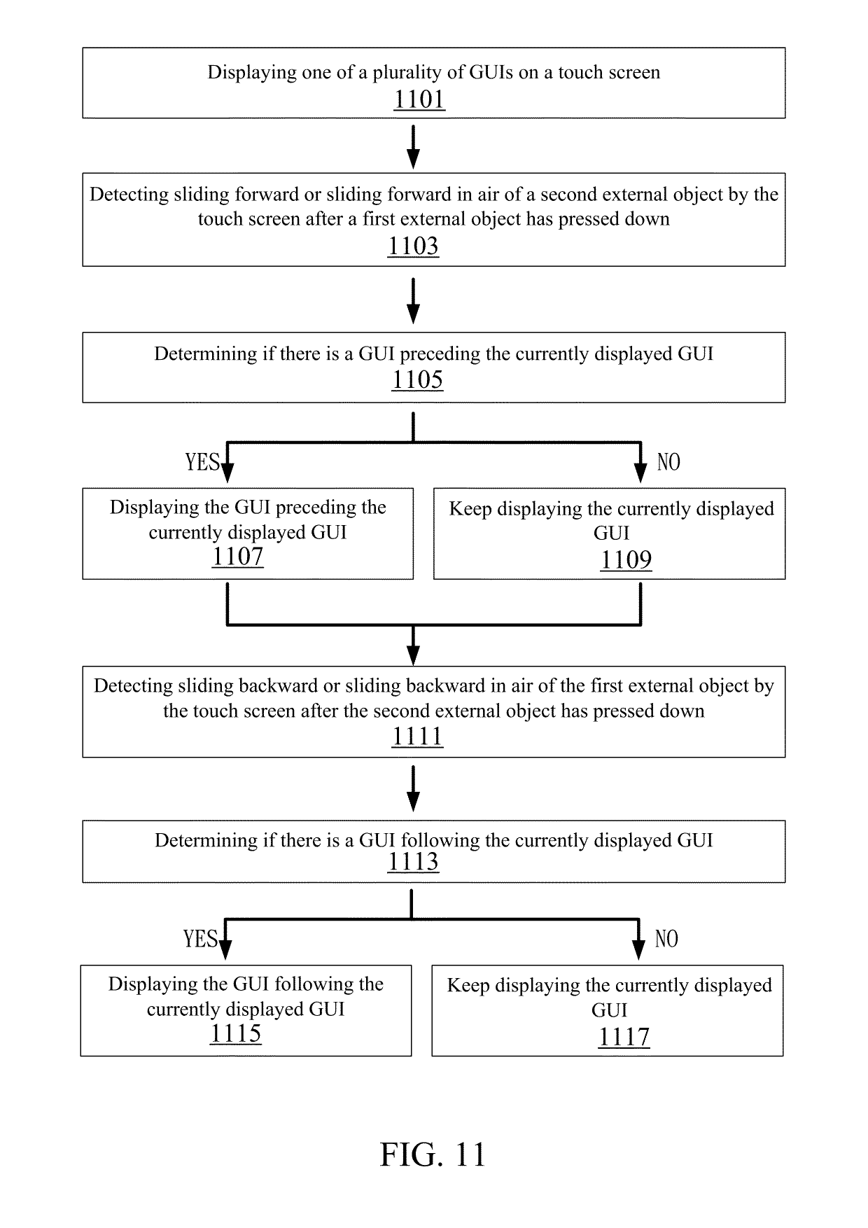

Therefore, the present invention performs the following steps in accordance to the above method, as shown in FIG. 11. In step 1101, one of a plurality of GUIs is displayed by a touch screen. In step 1103, sliding forward or sliding forward in air of a second external object after a first external object has pressed down is detected by the touch screen, and in step 1105, it is determined whether there is a GUI preceding the currently displayed GUI. If so, then in step 1107, the GUI preceding the currently displayed GUI is displayed on the touch screen. If not, then in step 1109, the GUI currently being displayed is still displayed.

After step 1107 or 1109, in step 1111, sliding backward or sliding backward in air of the second external object after the first external object has pressed down is detected by the touch screen, and in step 1113, it is determined whether there is a GUI following the currently displayed GUI. If so, then in step 1115, the GUI following the currently displayed GUI is displayed on the touch screen. If not, then in step 1117, the GUI currently being displayed is still displayed.

Accordingly, the present invention proposes a display device 800 for GUIs, which includes a touch screen 810 and a processor 820, as shown in FIG. 8A. The touch screen 810 displays one of a plurality of GUIs G1, G2, G3 . . . Gn−2, Gn−1 and Gn, the GUIs are arranged in a sequential order, which defines a GUI preceding and/or a GUI following the currently displayed GUI. The processor 820 detects sliding forward or sliding forward in air of a second external object after a first external object has pressed down, and if there is a GUI preceding the currently displayed GUI, then the GUI preceding the currently displayed GUI is displayed on the touch screen 810. The processor 820 further detects sliding backward or sliding backward in air of the second external object after the first external object has pressed down, and if there is a GUI following the currently displayed GUI, then the GUI following the currently displayed GUI is displayed on the touch screen 810, wherein the first external object is at a first side of the second external object, and the second external object is at a second side of the first external object, wherein the first and second sides are opposite sides.

Similarly, the present invention further proposes another method for displaying GUIs, which includes the following steps. First, one of a plurality of GUIs is displayed by a touch screen, and the GUIs are arranged in a sequential order, which defines a GUI preceding and/or a GUI following the currently displayed GUI. Then, after a first and a second external object have simultaneously pressed down, lifting, sliding or sliding in air of the second external object is detected by the touch screen, and if there is a GUI following the currently displayed GUI, then the GUI following the currently displayed GUI is displayed on the touch screen. This method further includes the following steps. After the first and second external objects have simultaneously pressed down, lifting, sliding or sliding in air of the first external object is detected by the touch screen, and if there is a GUI preceding the currently displayed GUI, then the GUI preceding the currently displayed GUI is displayed on the touch screen.

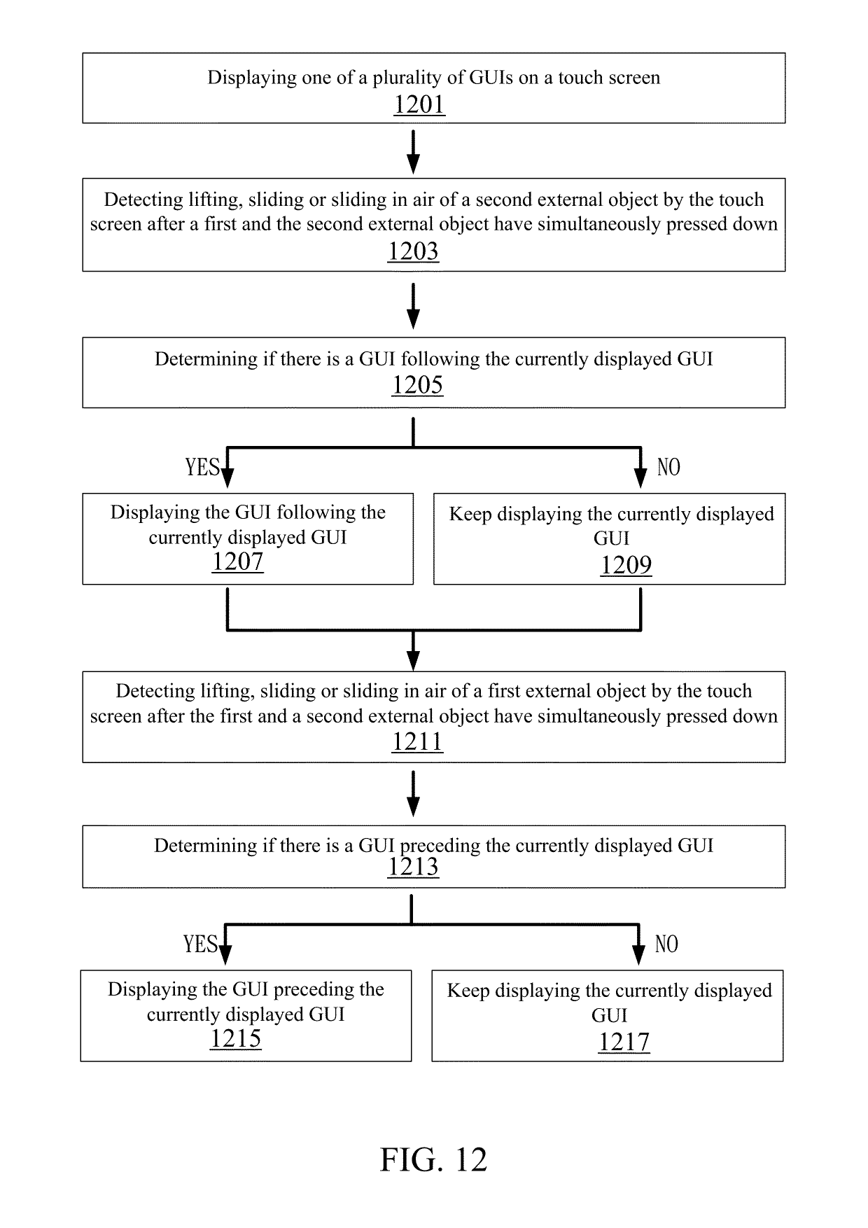

Therefore, the present invention performs the following steps in accordance to the above method, as shown in FIG. 12. In step 1201, one of a plurality of GUIs is displayed by a touch screen. In step 1203, after a first and a second external object have simultaneously pressed down, lifting, sliding or sliding in air of the second external object is detected by the touch screen, and in step 1205, it is determined whether there is a GUI following the currently displayed GUI. If so, then in step 1207, the GUI following the currently displayed GUI is displayed on the touch screen. If not, then in step 1209, the GUI currently being displayed is still displayed.

After step 1207 or 1209, in step 1211, after the first and second external objects have simultaneously pressed down, lifting, sliding or sliding in air of the first external object is detected by the touch screen, and in step 1213, it is determined whether there is a GUI preceding the currently displayed GUI. If so, then in step 1215, the GUI preceding the currently displayed GUI is displayed on the touch screen. If not, then in step 1217, the GUI currently being displayed is still displayed.

Accordingly, the present invention proposes a display device 800 for GUIs, which includes a touch screen 810 and a processor 820, as shown in FIG. 8A. The touch screen 810 displays one of a plurality of GUIs G1, G2, G3 . . . Gn−2, Gn−1 and Gn, the GUIs are arranged in a sequential order, which defines a GUI preceding and/or a GUI following the currently displayed GUI. The processor 820 detects, after a first and a second external object have simultaneously pressed down, lifting, sliding or sliding in air of the second external object, and if there is a GUI following the currently displayed GUI, then the GUI following the currently displayed GUI is displayed on the touch screen 810. The processor 820 further detects, after the first and second external objects have simultaneously pressed down, lifting, sliding or sliding in air of the first external object, and if there is a GUI preceding the currently displayed GUI, then the GUI preceding the currently displayed GUI is displayed on the touch screen 810, wherein the first external object is at a first side of the second external object, and the second external object is at a second side of the first external object, wherein the first and second sides are opposite sides.

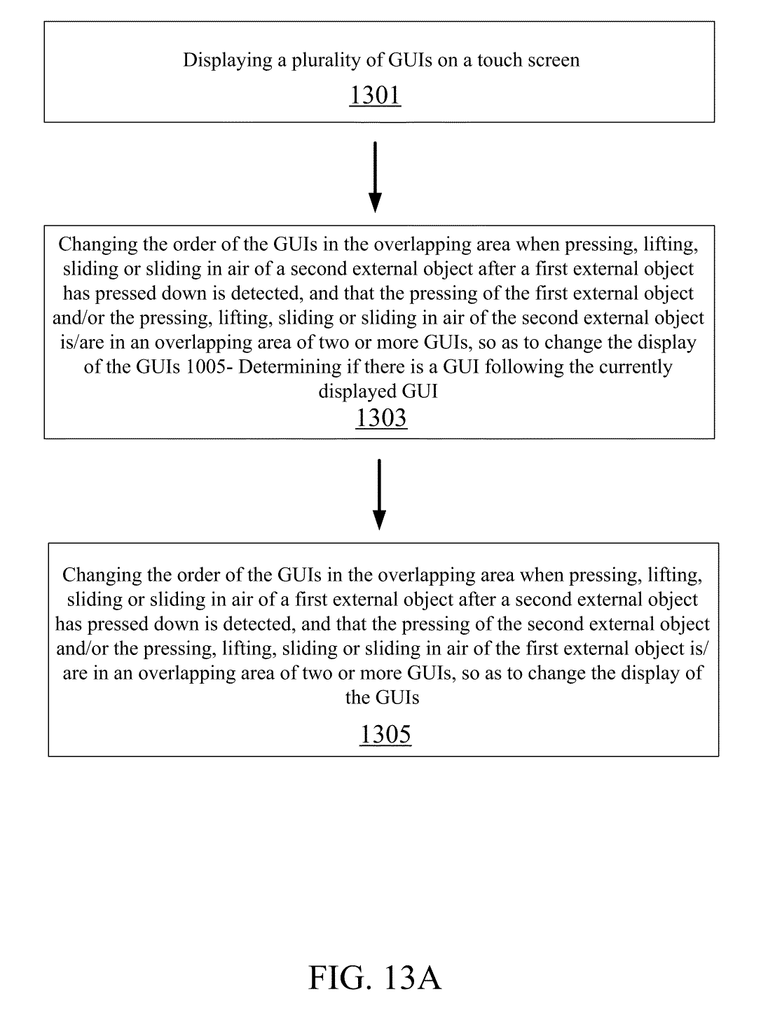

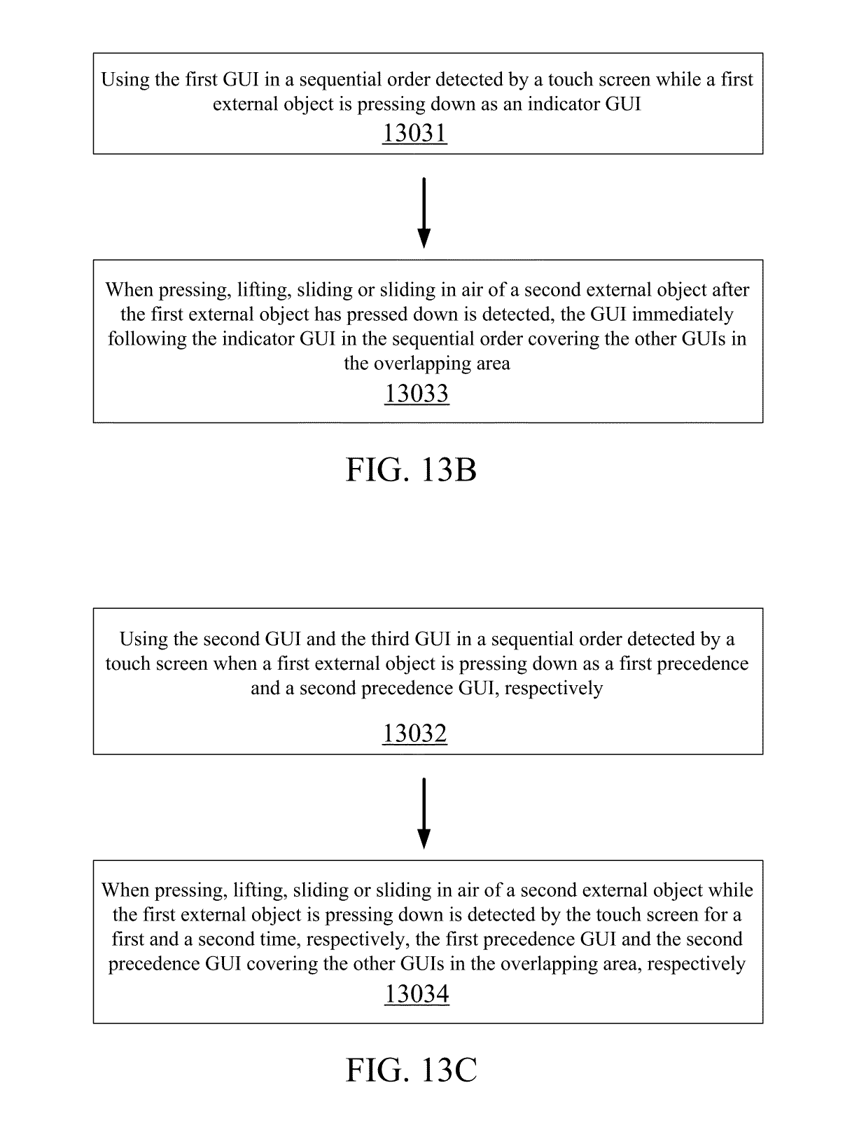

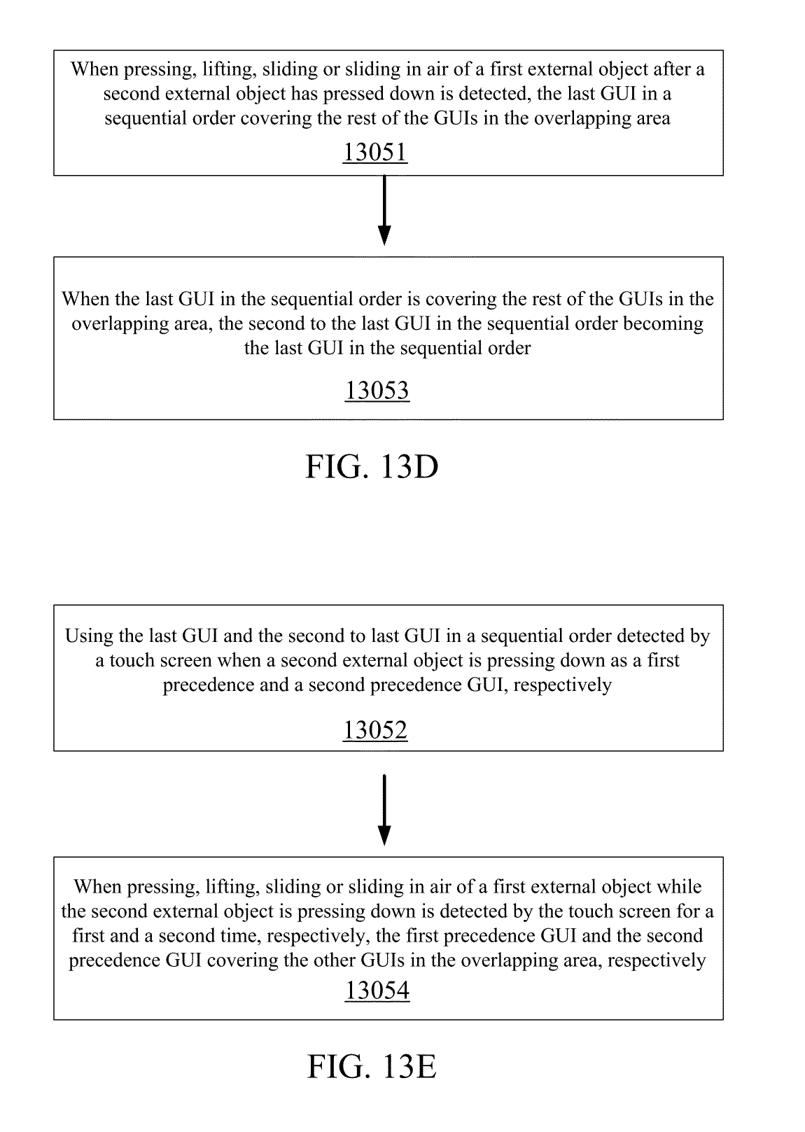

When the topmost GUI does not completely cover the rest of the GUIs, the touch screen will display a plurality of GUIs at the same time. Thus, the present invention proposes a method for displaying GUIs, which includes the following steps, as shown in FIG. 13A. First, in step 1301, a plurality of GUIs are displayed by a touch screen. If two or more of the GUIs overlap with each other, then these GUIs are arranged in a sequential order, which defines a GUI preceding and/or a GUI following the first GUI in the sequential order, wherein the first GUI in the sequential order covers all the other following GUIs, that is, the first GUI in the sequential order is situated at the topmost layer among all the GUIs.

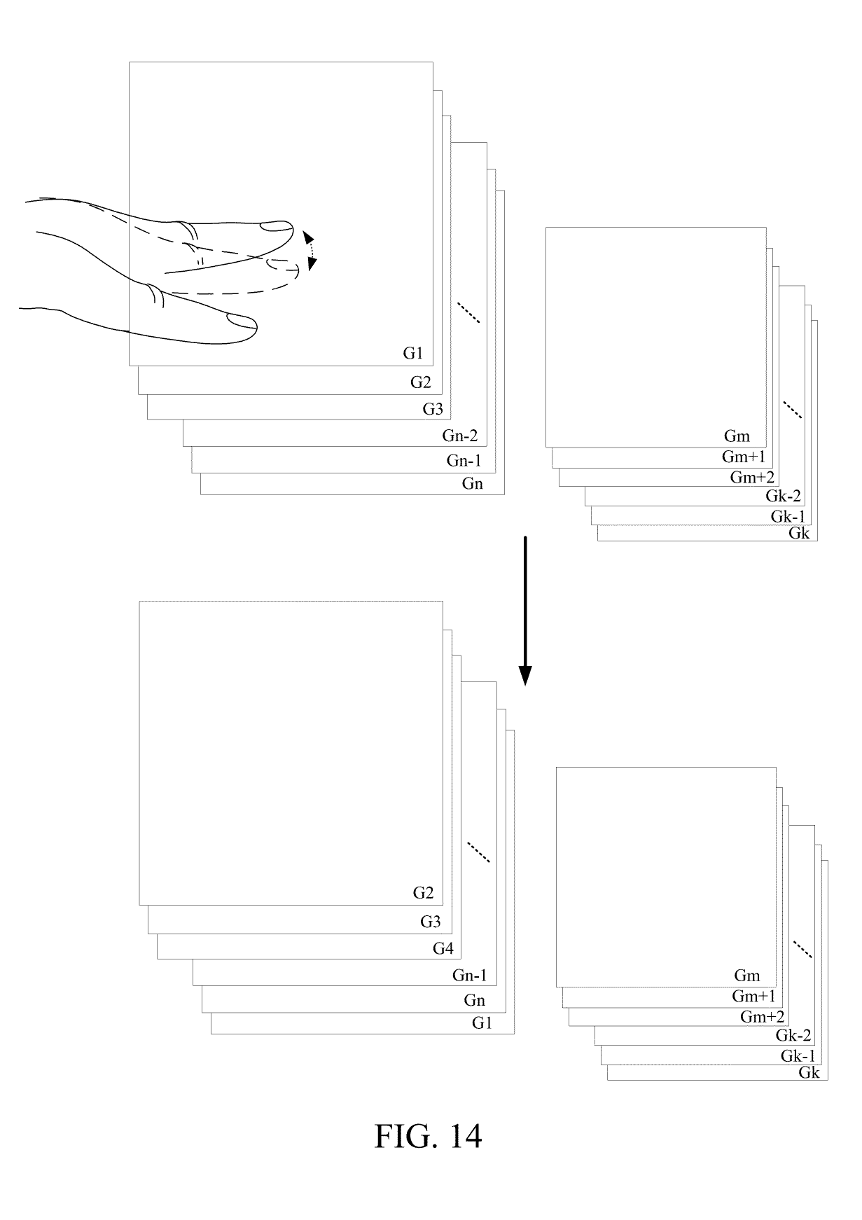

Then, in step 1303, when pressing, lifting, sliding or sliding in air of a second external object after a first external object has pressed down is detected, and that the pressing of the first external object and/or the pressing, lifting, sliding or sliding in air of the second external object is/are in an overlapping area of two or more GUIs, the order of the GUIs in the overlapping area is changed, and so the display of the GUIs is changed. For example, GUIs G1, G2, G3 . . . Gn−2, Gn−1 and Gn overlap with each other, and GUIs Gm, Gm+1, Gm+2 . . . Gk−2, Gk−1 and Gk overlap with each other, but GUIs G1, G2, G3 . . . Gn−2, Gn−1 and Gn and GUIs Gm, Gm+1, Gm+2 . . . Gk−2, Gk−1 and Gk exist independently and do not overlap with each other, as shown in FIG. 14. When pressing of a left finger and/or pressing, lifting, sliding or sliding in air of a right finger is/are in an overlapping area of the GUIs G1, G2, G3 . . . Gn−2, Gn−1 and Gn, the order in which the GUIs G1, G2, G3 . . . Gn−2, Gn−1 and Gn are arranged will be changed, so that the display of the GUIs G1, G2, G3 . . . Gn−2, Gn−1 and Gn becomes G2, G3, G4 . . . Gn−1, Gn and G1, but this does not affect the order in which the GUIs Gm, Gm+1, Gm+2 . . . Gk−2, Gk−1 and Gk are arranged.

The above changing of the order of the GUIs in an overlapping area includes the following steps, as shown in FIG. 13B. First, in step 13031, a first GUI in a sequential order detected by a touch screen while a first external object is pressing down is used as an indicator GUI. For example, when a left finger is pressing down, the first GUI G1 in the GUIs G1, G2, G3 . . . Gn−2, Gn−1 and Gn is used as the indicator GUI.

Then, in step 13033, when pressing, lifting, sliding or sliding in air of a second external object after the first external object has pressed down is detected, the GUI immediately following the indicator GUI in the sequential order covers the other GUIs in the overlapping area. For example, when pressing, lifting, sliding or sliding in air of a right finger after a left finger has pressed down is detected, the GUI G2 immediately following the indicator GUI G1 in the sequential order covers the other GUIs in the overlapping area.

In addition, when the GUI immediately following the indicator GUI in the sequential order is covering the other GUIs in the overlapping area, the second GUI following the indicator GUI becomes the first GUI following the indicator GUI. For example, when the GUI G2 immediately following the indicator GUI G1 in the sequential order is covering the other GUIs in the overlapping area, the second GUI G3 following the indicator GUI G1 becomes the first GUI following the indicator GUI G1, now the order of the GUIs becomes G2, G1, G3 . . . Gn−2, Gn−1 and Gn.

Similarly, the above changing of the order of the GUIs in an overlapping area includes the following steps, as shown in FIG. 13C. First, in step 13032, the second GUI and the third GUI in a sequential order detected by a touch screen when a first external object is pressing down are used as a first precedence and a second precedence GUI, respectively. Thereafter, in step 13034, when pressing, lifting, sliding or sliding in air of a second external object while the first external object is pressing down is detected by the touch screen for a first and a second time, respectively, the first precedence GUI and the second precedence GUI covers the other GUIs in the overlapping area, respectively.

This method for displaying GUIs further includes the following steps, as shown in FIG. 13A. In step 1305, when pressing, lifting, sliding or sliding in air of the first external object after the second external object has pressed down is detected, and that the pressing of the second external object and/or the pressing, lifting, sliding or sliding in air of the first external object is/are in an overlapping area of two or more GUIs, the order of the GUIs in the overlapping area is changed, and so the display of the GUIs is changed.

The above changing of the order of the GUIs in an overlapping area includes the following steps, as shown in FIG. 13D. First, in step 13051, when pressing, lifting, sliding or sliding in air of a first external object after a second external object has pressed down is detected, the last GUI in a sequential order covers the rest of the GUIs in the overlapping area, wherein in step 13053, when the last GUI in the sequential order is covering the rest of the GUIs in the overlapping area, the second to the last GUI in the sequential order becomes the last GUI in the sequential order. For example, pressing, lifting, sliding or sliding in air of a left finger after a right finger has pressed down will cause the last GUI Gn in a sequential order of G1, G2, G3 . . . Gn−2, Gn−1 and Gn to cover the rest of the GUIs in the overlapping area, and the second to the last GUI Gn−1 in the sequential order becomes the last GUI in the sequential order.

Similarly, the above changing of the order of the GUIs in an overlapping area includes the following steps, as shown in FIG. 13E. First, in step 13052, the last GUI and the second to last GUI in a sequential order detected by a touch screen when a second external object is pressing down are used as a first precedence and a second precedence GUI, respectively. Thereafter, in step 13054, when pressing, lifting, sliding or sliding in air of a first external object while the second external object is pressing down is detected by the touch screen for a first and a second time, respectively, the first precedence GUI and the second precedence GUI covers the other GUIs in the overlapping area, respectively.

Accordingly, the present invention proposes a display device 800 for GUIs, which includes a touch screen 810 and a processor 820, as shown in FIG. 8B. The touch screen 810 displays a plurality of GUIs G1, G2, G3 . . . Gn−2, Gn−1 and Gn, two or more of the GUIs overlap with each other, and these GUIs are arranged in a sequential order, which defines a GUI preceding and/or a GUI following the first GUI in the sequential order, wherein the first GUI in the sequential order covers all the following GUIs in the sequential order. When the touch screen 810 detects pressing, lifting, sliding or sliding in air of a second external object after a first external object has pressed down, and that the pressing of the first external object and/or the pressing, lifting, sliding or sliding in air of the second external object is/are in an overlapping area of two or more GUIs, the processor 820 changes the order of the GUIs in the overlapping area, and so the display of the GUIs is changed. Furthermore, when the touch screen 810 detects pressing, lifting, sliding or sliding in air of the first external object after the second external object has pressed down, and that the pressing of the second external object and/or the pressing, lifting, sliding or sliding in air of the first external object is/are in an overlapping area of two or more GUIs, the processor 820 changes the order of the GUIs in the overlapping area is changed, and so the display of the GUIs is changed, wherein the first external object is at a first side of the second external object, and the second external object is at a second side of the first external object, wherein the first and second sides are opposite sides.

The processor 820 changing the order of the GUIs in the overlapping area includes the following steps. First, a first GUI in a sequential order detected by the touch screen 810 while the first external object is pressing down is used as an indicator GUI. Then, when pressing, lifting, sliding or sliding in air of the second external object after the first external object has pressed down is detected by the touch screen 810, the GUI immediately following the indicator GUI in the sequential order covers the other GUIs in the overlapping area, wherein when the GUI immediately following the indicator GUI in the sequential order is covering the other GUIs in the overlapping area, the second GUI following the indicator GUI becomes the first GUI following the indicator GUI.

Furthermore, the processor 820 changing the order of the GUIs in the overlapping area includes the following steps. First, the second and third GUIs in a sequential order detected by the touch screen 810 when the first external object is pressing down are used as a first precedence and a second precedence GUI, respectively. Thereafter, when pressing, lifting, sliding or sliding in air of the second external object while the first external object is pressing down is detected by the touch screen 810 for a first and a second time, respectively, the first precedence GUI and the second precedence GUI covers the other GUIs in the overlapping area, respectively.

The processor 820 further includes that, when pressing, lifting, sliding or sliding in air of the first external object after the second external object has pressed down is detected by the touch screen 810, and that the pressing of the second external object and/or the pressing, lifting, sliding or sliding in air of the first external object is/are in an overlapping area of two or more GUIs, changing the order of the GUIs in the overlapping area, and so the display of the GUIs is changed, wherein the first external object is at a first side of the second external object, and the second external object is at a second side of the first external object, wherein the first and second sides are opposite sides. At this time, the processor 820 changing the order of the GUIs in the overlapping area further includes, when pressing, lifting, sliding or sliding in air of a first external object after a second external object has pressed down is detected by the touch screen 810, allowing the last GUI in a sequential order to cover the rest of the GUIs in the overlapping area, wherein the first and second sides are opposite sides, and when the last GUI in the sequential order is covering the rest of the GUIs in the overlapping area, the second to the last GUI in the sequential order becomes the last GUI in the sequential order.

The processor 820 changing the order of the GUIs in the overlapping area also includes the following steps. First, the last GUI and the second to last GUI in a sequential order detected by the touch screen 810 when a second external object is pressing down are used as a first precedence and a second precedence GUI, respectively. Thereafter, when pressing, lifting, sliding or sliding in air of a first external object while the second external object is pressing down is detected by the touch screen 810 for a first and a second time, respectively, the first precedence GUI and the second precedence GUI covers the other GUIs in the overlapping area, respectively.

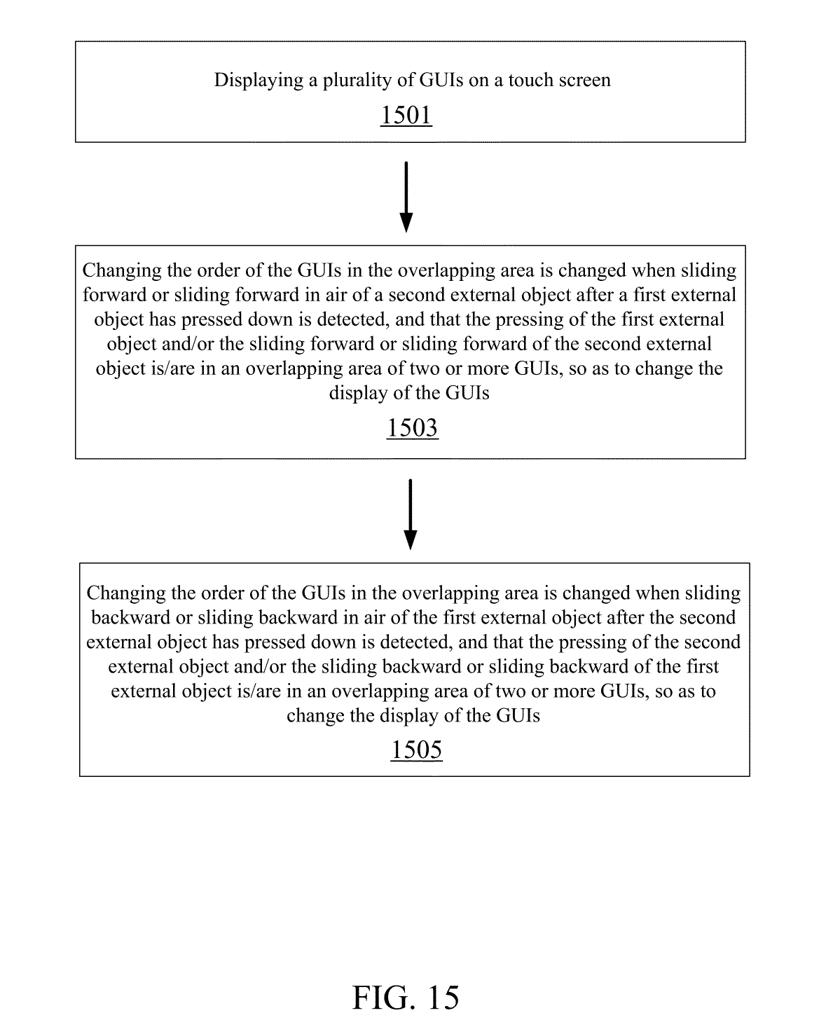

The present invention proposes another method for displaying GUIs, which includes the following steps, as shown in FIG. 15. First, in step 1501, a plurality of GUIs are displayed by a touch screen. If two or more of the GUIs overlap with each other, then these GUIs are arranged in a sequential order, which defines a GUI preceding and/or a GUI following the first GUI in the sequential order, wherein the first GUI in the sequential order covers all the other following GUIs in the sequential order.

Then, in step 1503, when sliding forward or sliding forward in air of a second external object after a first external object has pressed down is detected, and that the pressing of the first external object and/or the sliding forward or sliding forward of the second external object is/are in an overlapping area of two or more GUIs, the order of the GUIs in the overlapping area is changed, and so the display of the GUIs is changed.

This method for displaying GUIs further includes the following steps. In step 1505, when sliding backward or sliding backward in air of the first external object after the second external object has pressed down is detected, and that the pressing of the second external object and/or the sliding backward or sliding backward of the first external object is/are in an overlapping area of two or more GUIs, the order of the GUIs in the overlapping area is changed, and so the display of the GUIs is changed.

Accordingly, the present invention proposes a display device 800 for GUIs, which includes a touch screen 810 and a processor 820, as shown in FIG. 8B. The touch screen 810 displays a plurality of GUIs G1, G2, G3 . . . Gn−2, Gn−1 and Gn, two or more of the GUIs overlap with each other, and these GUIs are arranged in a sequential order, which defines a GUI preceding and/or a GUI following the first GUI in the sequential order, wherein the first GUI in the sequential order covers all the following GUIs in the sequential order. When the touch screen 810 detects sliding forward or sliding forward in air of a second external object after a first external object has pressed down, and that the pressing of the first external object and/or the sliding forward or sliding forward in air of the second external object is/are in an overlapping area of two or more GUIs, the processor 820 changes the order of the GUIs in the overlapping area, and so the display of the GUIs is changed. Further, when touch screen 810 detects sliding backward or sliding backward in air of the first external object after the second external object has pressed down, and that the pressing of the second external object and/or the sliding backward or sliding backward in air of the first external object is/are in an overlapping area of two or more GUIs, the processor 820 changes the order of the GUIs in the overlapping area is changed, and so the display of the GUIs is changed, wherein the first external object is at a first side of the second external object, and the second external object is at a second side of the first external object, wherein the first and second sides are opposite sides.

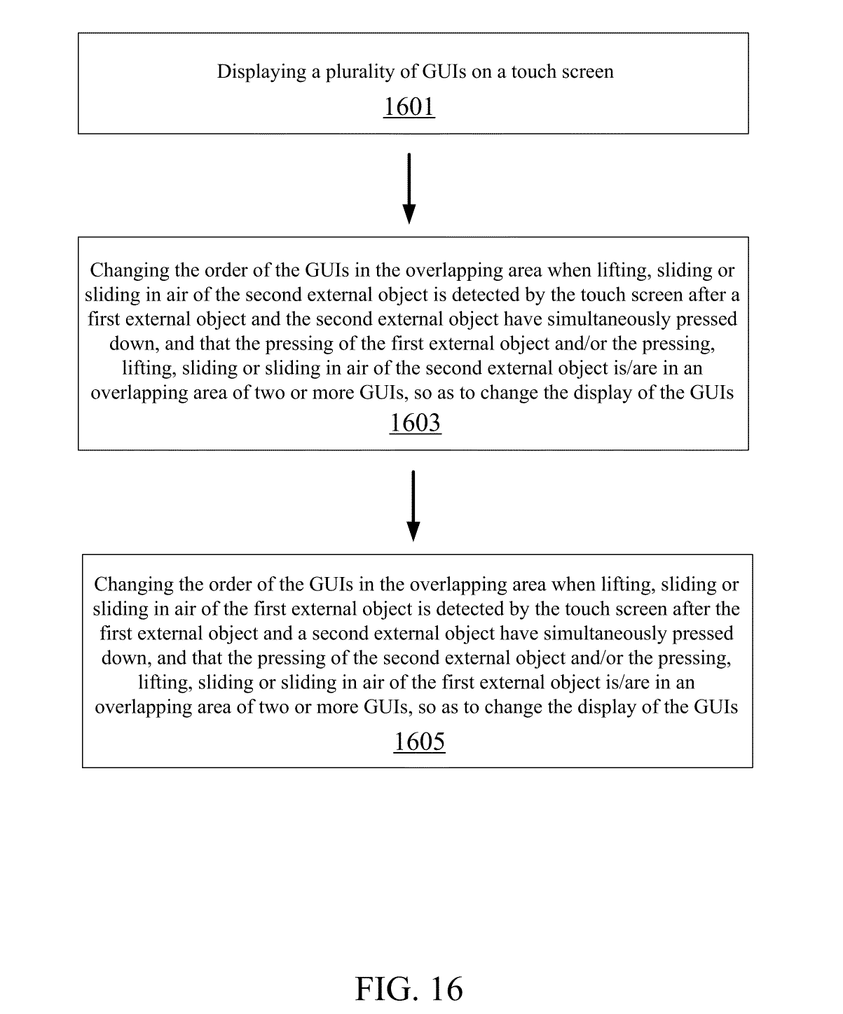

Moreover, the present invention proposes another method for displaying GUIs, which includes the following steps, as shown in FIG. 16. First, in step 1601, a plurality of GUIs are displayed by a touch screen. If two or more of the GUIs overlap with each other, then these GUIs are arranged in a sequential order, which defines a GUI preceding and/or a GUI following the first GUI in the sequential order, wherein the first GUI in the sequential order covers all the other following GUIs in the sequential order. Thereafter, in step 1603, after a first external object and a second external object have simultaneously pressed down, lifting, sliding or sliding in air of the second external object is detected by the touch screen, and that the pressing of the first external object and/or the pressing, lifting, sliding or sliding in air of the second external object is/are in an overlapping area of two or more GUIs, the order of the GUIs in the overlapping area is changed, and so the display of the GUIs is changed.

This method for displaying GUIs further includes the following steps. In step 1605, after a first external object and a second external object have simultaneously pressed down, lifting, sliding or sliding in air of the first external object is detected by the touch screen, and that the pressing of the second external object and/or the pressing, lifting, sliding or sliding in air of the first external object is/are in an overlapping area of two or more GUIs, the order of the GUIs in the overlapping area is changed, and so the display of the GUIs is changed.

Accordingly, the present invention proposes a display device 800 for GUIs, which includes a touch screen 810 and a processor 820, as shown in FIG. 8B. The touch screen 810 displays a plurality of GUIs G1, G2, G3 . . . Gn−2, Gn−1 and Gn, two or more of the GUIs overlap with each other, and these GUIs are arranged in a sequential order, which defines a GUI preceding and/or a GUI following the first GUI in the sequential order, wherein the first GUI in the sequential order covers all the following GUIs in the sequential order. After a first external object and a second external object have simultaneously pressed down, lifting, sliding or sliding in air of the second external object is detected by the touch screen 810, and that the pressing of the first external object and/or the lifting, sliding or sliding in air of the second external object is/are in an overlapping area of two or more GUIs, the processor 820 changes the order of the GUIs in the overlapping area, and so the display of the GUIs is changed. Furthermore, after a first external object and a second external object have simultaneously pressed down, lifting, sliding or sliding in air of the first external object is detected by the touch screen 810, and that the pressing of the second external object and/or the lifting, sliding or sliding in air of the first external object is/are in an overlapping area of two or more GUIs, the processor 820 changes the order of the GUIs in the overlapping area, and so the display of the GUIs is changed, wherein the first external object is at a first side of the second external object, and the second external object is at a second side of the first external object, wherein the first and second sides are opposite sides.

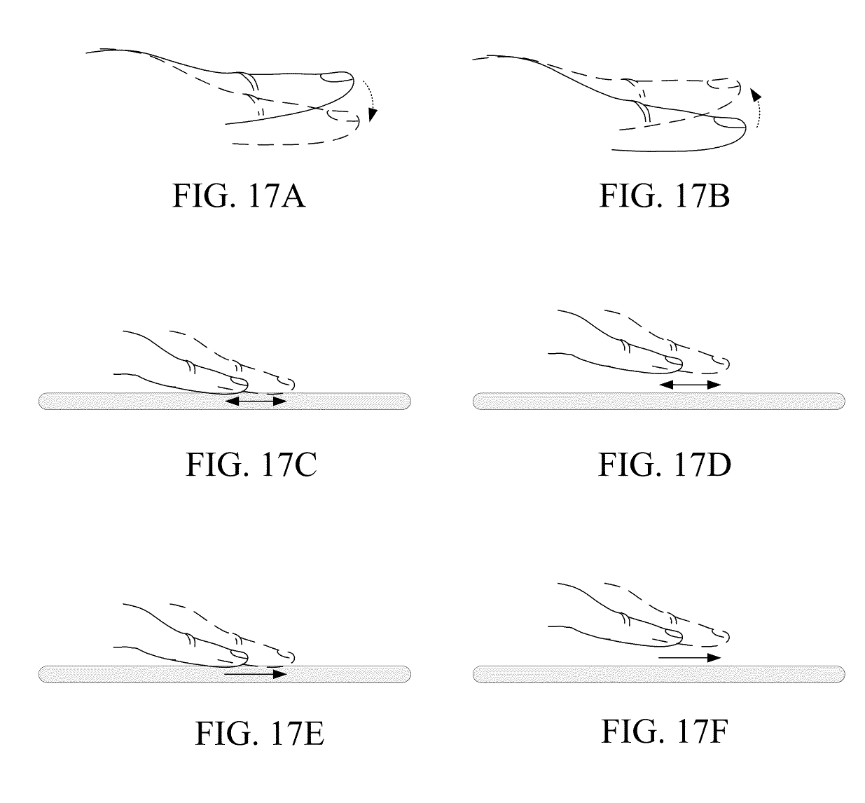

The above gestures such as pressing, lifting, sliding, sliding in air, sliding forward and sliding forward in air are shown in FIGS. 17A, 17B, 17C, 17D, 17E, 17F and 17G, respectively. When an external object presses down onto the touch screen, the touch screen detects the above touch signal. Then, when the external object lifts up, the touch signal then disappears, so that the processor can calculate the duration of the touch signal. If the duration of the touch signal exceeds the above predetermined period of time, then the processor determines this touch signal is the above pressing signal. On the contrary, if the duration of the touch signal is less than the above predetermined period of time, then the processor determines this touch signal is the above clicking signal. Moreover, when the touch screen detects sliding, sliding in air, sliding forward and sliding forward in air, the above sliding signal is generated.

The above pressing, lifting or sliding of the second external object after the first external object has pressed down is one selected from the group consisting of: the pressing of the second external object when the first external object is pressing; the pressing and then lifting of the second external object when the first external object is pressing; the sliding of the second external object when the first external object is pressing; the sliding in air of the second external object when the first external object is pressing; the pressing of the second external object after the first external object has pressed and then lifted; the pressing and then lifting of the second external object after the first external object has pressed and then lifted; the sliding of the second external object after the first external object has pressed and lifted; and the sliding in air of the second external object after the first external object has pressed and lifted.

Similarly, the above pressing, lifting or sliding of the first external object after the second external object has pressed down is one selected from the group consisting of: the pressing of the first external object when the second external object is pressing; the pressing and then lifting of the first external object when the second external object is pressing; the sliding of the first external object when the second external object is pressing; the sliding in air of the first external object when the second external object is pressing; the pressing of the first external object after the second external object has pressed and then lifted; the pressing and then lifting of the first external object after the second external object has pressed and then lifted; the sliding of the first external object after the second external object has pressed and lifted; and the sliding in air of the first external object after the second external object has pressed and lifted.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A method for displaying graphical user interfaces (GUIs), comprising:
displaying one of a plurality of GUIs on a touch screen, the GUIs being arranged in a sequential order which defines a GUI preceding and/or a GUI following the currently displayed GUI;
detecting pressing, lifting, sliding or sliding in air of a second external object by the touch screen while pressing of a first external object has been detected by the touch screen; and
displaying the GUI following the currently displayed GUI.

2. The method of claim 1, further comprising:
detecting pressing, lifting, sliding or sliding in air of a first external object by the touch screen while pressing of a second external object has been detected by the touch screen; and
displaying the GUI preceding the currently displayed GUI,
wherein the first external object is at a first side of the second external object, and the second external object is at a second side of the first external object, wherein the first and second sides are opposite sides.

3. The method of claim 1, wherein the pressing, lifting, sliding or sliding in air of the second external object after the first external object has pressed down is one selected from the group consisting of:
the pressing of the second external object when the first external object is pressing;
the pressing and then lifting of the second external object when the first external object is pressing;
the sliding of the second external object when the first external object is pressing; the sliding in air of the second external object when the first external object is pressing;
the pressing of the second external object after the first external object has pressed and then lifted;
the pressing and then lifting of the second external object after the first external object has pressed and then lifted;
the sliding of the second external object after the first external object has pressed and lifted; and
the sliding in air of the second external object after the first external object has pressed and lifted.

4. The method of claim 1, wherein the pressing, lifting, sliding or sliding in air of the first external object after the second external object has pressed down is one selected from the group consisting of:
the pressing of the first external object when the second external object is pressing;
the pressing and then lifting of the first external object when the second external object is pressing;
the sliding of the first external object when the second external object is pressing;
the sliding in air of the first external object when the second external object is pressing;
the pressing of the first external object after the second external object has pressed and then lifted;
the pressing and then lifting of the first external object after the second external object has pressed and then lifted;
the sliding of the first external object after the second external object has pressed and lifted; and
the sliding in air of the first external object after the second external object has pressed and lifted.

5. The method of claim 1, wherein the sequential order is presented as a non-cyclic queue, in which the first GUI in the sequential order does not have a preceding GUI, and the last GUI in the sequential order does not have a following GUI.

6. The method of claim 1, wherein the sequential order is presented as a cyclic queue, in which each GUI has a preceding GUI and a following GUI.

7. A device for displaying graphical user interfaces (GUIs), comprising:
a touch screen for displaying one of a plurality of GUIs, the GUIs being arranged in a sequential order which defines a GUI preceding and/or a GUI following the currently displayed GUI; and
a processor for detecting pressing, lifting, sliding or sliding in air of a second external object while pressing of a first external object has been detected, and displaying the GUI following the currently displayed GUI on the touch screen.

8. The device of claim 7, where the processor further detects pressing, lifting, sliding or sliding in air of a first external object while pressing of a second external object has been detected, and displays the GUI preceding the currently displayed GUI on the touch screen, wherein the first external object is at a first side of the second external object, and the second external object is at a second side of the first external object, wherein the first and second sides are opposite sides.

9. The device of claim 7, wherein the pressing, lifting, sliding or sliding in air of the second external object after the first external object has pressed down is one selected from the group consisting of:
the pressing of the second external object when the first external object is pressing;
the pressing and then lifting of the second external object when the first external object is pressing;
the sliding of the second external object when the first external object is pressing; the sliding in air of the second external object when the first external object is pressing;
the pressing of the second external object after the first external object has pressed and then lifted;
the pressing and then lifting of the second external object after the first external object has pressed and then lifted;
the sliding of the second external object after the first external object has pressed and lifted; and
the sliding in air of the second external object after the first external object has pressed and lifted.

10. The device of claim 7, wherein the pressing, lifting, sliding or sliding in air of the first external object after the second external object has pressed down is one selected from the group consisting of:
the pressing of the first external object when the second external object is pressing;
the pressing and then lifting of the first external object when the second external object is pressing;
the sliding of the first external object when the second external object is pressing;
the sliding in air of the first external object when the second external object is pressing;
the pressing of the first external object after the second external object has pressed and then lifted;
the pressing and then lifting of the first external object after the second external object has pressed and then lifted;
the sliding of the first external object after the second external object has pressed and lifted; and
the sliding in air of the first external object after the second external object has pressed and lifted.

11. The device of claim 7, wherein the sequential order is presented as a non-cyclic queue, in which the first GUI in the sequential order does not have a preceding GUI, and the last GUI in the sequential order does not have a following GUI.

12. The device of claim 7, wherein the sequential order is presented as a cyclic queue, in which each GUI has a preceding GUI and a following GUI.

13. A method for displaying graphical user interfaces (GUIs), comprising:
displaying one of a plurality of GUIs on a touch screen, the GUIs being arranged in a sequential order which defines a GUI preceding and/or a GUI following the currently displayed GUI; and
detecting sliding forward or sliding forward in air of a second external object by the touch screen while pressing of a first external object has been detected by the touch screen, and displaying the GUI preceding the currently displayed GUI.

14. The method of claim 13, further comprising:
displaying one of a plurality of GUIs on a touch screen, the GUIs being arranged in a sequential order which defines a GUI preceding and/or a GUI following the currently displayed GUI; and
detecting sliding backward or sliding backward in air of a second external object by the touch screen while pressing of a first external object has been detected by the touch screen, and displaying the GUI following the currently displayed GUI,
wherein the first external object is at a first side of the second external object, and the second external object is at a second side of the first external object, wherein the first and second sides are opposite sides.

15. The method of claim 13, wherein the sequential order is presented as a non-cyclic queue, in which the first GUI in the sequential order does not have a preceding GUI, and the last GUI in the sequential order does not have a following GUI.

16. The method of claim 13, wherein the sequential order is presented as a cyclic queue, in which each GUI has a preceding GUI and a following GUI.

17. A device for displaying graphical user interfaces (GUIs), comprising:
a touch screen for displaying one of a plurality of GUIs, the GUIs being arranged in a sequential order which defines a GUI preceding and/or a GUI following the currently displayed GUI; and
a processor for detecting sliding forward or sliding forward in air of a second external object while pressing of a first external object has pressed down, and displaying the GUI preceding the currently displayed GUI.

18. The device of claim 17, wherein the processor further detects sliding backward or sliding backward in air of a second external object while pressing of a first external object has pressed down, and displays the GUI following the currently displayed GUI, wherein the first external object is at a first side of the second external object, and the second external object is at a second side of the first external object, wherein the first and second sides are opposite sides.

19. The device of claim 17, wherein the sequential order is presented as a non-cyclic queue, in which the first GUI in the sequential order does not have a preceding GUI, and the last GUI in the sequential order does not have a following GUI.

20. The device of claim 17, wherein the sequential order is presented as a cyclic queue, in which each GUI has a preceding GUI and a following GUI.

21. A method for displaying graphical user interfaces (GUIs), comprising:
displaying one of a plurality of GUIs on a touch screen, the GUIs being arranged in a sequential order which defines a GUI preceding and/or a GUI following the currently displayed GUI; and
detecting lifting, sliding or sliding in air of a second external object by the touch screen while pressing of a first external object and the second external object have been detected by the touch screen simultaneously, and displaying the GUI following the currently displayed GUI.

22. The method of claim 21, further comprising:
detecting lifting, sliding or sliding in air of a first external object by the touch screen while pressing of the first external object and a second external object have been detected by the touch screen simultaneously, and displaying the GUI preceding the currently displayed GUI,
wherein the first external object is at a first side of the second external object, and the second external object is at a second side of the first external object, wherein the first and second sides are opposite sides.

23. A device for displaying graphical user interfaces (GUIs), comprising:
a touch screen for displaying one of a plurality of GUIs, the GUIs being arranged in a sequential order which defines a GUI preceding and/or a GUI following the currently displayed GUI; and
a processor for detecting lifting, sliding or sliding in air of a second external object while pressing of a first external object and the second external object have been detected simultaneously, and displaying the GUI following the currently displayed GUI.

24. The device of claim 23, wherein the processor further detects lifting, sliding or sliding in air of a first external object while pressing of the first external object and a second external object have been detected simultaneously, and displays the GUI preceding the currently displayed GUI, wherein the first external object is at a first side of the second external object, and the second external object is at a second side of the first external object, wherein the first and second sides are opposite sides.

25. A method for displaying graphical user interfaces (GUIs), comprising:
displaying a plurality of GUIs on a touch screen, when two or more of the GUIs overlap with each other, these GUIs being arranged in a sequential order which defines a GUI preceding and/or a GUI following the first GUI in the sequential order, wherein the first GUI in the sequential order covers all the following GUIs; and
detecting pressing, lifting, sliding or sliding in air of a second external object by the touch screen while pressing of a first external object has pressed down, and detecting the pressing of the first external object and/or the pressing, lifting, sliding or sliding in air of the second external object in an overlapping area of two or more GUIs, and thus changing the order of the GUIs in the overlapping area so as to change the display of the GUIs.

26. The method of claim 25, wherein changing the order of the GUIs in the overlapping area includes:
using the first GUI in the sequential order detected by the touch screen while the first external object is pressing down as an indicator GUI; and
detecting the pressing, lifting, sliding or sliding in air of the second external object while pressing of the first external object has been detected by the touch screen, and making the GUI immediately following the indicator GUI in the sequential order cover the other GUIs in the overlapping area,
wherein when the GUI immediately following the indicator GUI in the sequential order is covering the other GUIs in the overlapping area, the second GUI following the indicator GUI becomes the first GUI following the indicator GUI.

27. The method of claim 25, wherein the pressing, lifting, sliding or sliding in air of the first external object after the second external object has pressed down is one selected from the group consisting of:
the pressing of the first external object when the second external object is pressing;
the pressing and then lifting of the first external object when the second external object is pressing;
the sliding of the first external object when the second external object is pressing;
the sliding in air of the first external object when the second external object is pressing;
the pressing of the first external object after the second external object has pressed and then lifted;
the pressing and then lifting of the first external object after the second external object has pressed and then lifted;
the sliding of the first external object after the second external object has pressed and lifted; and
the sliding in air of the first external object after the second external object has pressed and lifted.

28. The method of claim 25, wherein the pressing, lifting, sliding or sliding in air of the second external object after the first external object has pressed down is one selected from the group consisting of:
the pressing of the second external object when the first external object is pressing;
the pressing and then lifting of the second external object when the first external object is pressing;
the sliding of the second external object when the first external object is pressing; the sliding in air of the second external object when the first external object is pressing;
the pressing of the second external object after the first external object has pressed and then lifted;
the pressing and then lifting of the second external object after the first external object has pressed and then lifted;
the sliding of the second external object after the first external object has pressed and lifted; and
the sliding in air of the second external object after the first external object has pressed and lifted.

29. The method of claim 25, wherein changing the order of the GUIs in the overlapping area includes:
using the second GUI and the third GUI in the sequential order detected by a touch screen when the first external object is pressing down as a first precedence and a second precedence GUI, respectively;
detecting pressing, lifting, sliding or sliding in air of the second external object by the touch screen while pressing of the first external object has been detected by the touch screen for a first and a second time, respectively, and making the first precedence GUI and the second precedence GUI cover the other GUIs in the overlapping area, respectively

30. The method of claim 25, further comprising:
detecting pressing, lifting, sliding or sliding in air of a first external object by the touch screen while pressing of a second external object has pressed down, and detecting the pressing of the second external object and/or the pressing, lifting, sliding or sliding in air of the first external object in an overlapping area of two or more GUIs, and thus changing the order of the GUIs in the overlapping area so as to change the display of the GUIs,
wherein the first external object is at a first side of the second external object, and the second external object is at a second side of the first external object, wherein the first and second sides are opposite sides.

31. The method of claim 30, wherein changing the order of the GUIs in the overlapping area includes:
detecting pressing, lifting, sliding or sliding in air of the first external object by the touch screen while pressing of the second external object has been detected by the touch screen, and making the last GUI in the sequential order cover the rest of the GUIs in the overlapping area, wherein the first and second sides are opposite sides;
where when the last GUI in the sequential order is covering the rest of the GUIs in the overlapping area, the second to last GUI in the sequential order becomes the last GUI in the sequential order.

32. The method of claim 25, wherein changing the order of the GUIs in the overlapping area includes:
using the last GUI and the second to last GUI in the sequential order detected by a touch screen when the first external object is pressing down as a first precedence and a second precedence GUI, respectively; and
detecting pressing, lifting, sliding or sliding in air of the first external object by the touch screen while pressing of the second first external object has been detected by the touch screen for a first and a second time, respectively, and making the first precedence GUI and the second precedence GUI cover the other GUIs in the overlapping area, respectively.

33. A device for displaying graphical user interfaces (GUIs), comprising:
a touch screen for displaying a plurality of GUIs, when two or more of the GUIs overlap with each other, these GUIs being arranged in a sequential order which defines a GUI preceding and/or a GUI following the first GUI in the sequential order, wherein the first GUI in the sequential order covers all the following GUIs; and
a processor for changing the order of the GUIs in the overlapping area when pressing, lifting, sliding or sliding in air of a second external object is detected by the touch screen while pressing of a first external object has been detected and that the pressing of the first external object and/or the pressing, lifting, sliding or sliding in air of the second external object is/are in an overlapping area of two or more GUIs, and thus changing the display of the GUIs.

34. The device of claim 33, wherein the processor changing the order of the GUIs in the overlapping area includes:
using the first GUI in the sequential order detected by the touch screen while the first external object is pressing down as an indicator GUI; and
detecting the pressing, lifting, sliding or sliding in air of the second external object by the touch screen while pressing of the first external object has been detected by the touch screen, and thus making the GUI immediately following the indicator GUI in the sequential order cover the other GUIs in the overlapping area,
wherein when the GUI immediately following the indicator GUI in the sequential order is covering the other GUIs in the overlapping area, the second GUI following the indicator GUI becomes the first GUI following the indicator GUI.

35. The device of claim 33, wherein the pressing, lifting, sliding or sliding in air of the first external object after the second external object has pressed down is one selected from the group consisting of:
the pressing of the first external object when the second external object is pressing;
the pressing and then lifting of the first external object when the second external object is pressing;
the sliding of the first external object when the second external object is pressing;
the sliding in air of the first external object when the second external object is pressing;
the pressing of the first external object after the second external object has pressed and then lifted;
the pressing and then lifting of the first external object after the second external object has pressed and then lifted;
the sliding of the first external object after the second external object has pressed and lifted; and
the sliding in air of the first external object after the second external object has pressed and lifted.

36. The device of claim 33, wherein the pressing, lifting, sliding or sliding in air of the second external object after the first external object has pressed down is one selected from the group consisting of:
the pressing of the second external object when the first external object is pressing;
the pressing and then lifting of the second external object when the first external object is pressing;
the sliding of the second external object when the first external object is pressing; the sliding in air of the second external object when the first external object is pressing;
the pressing of the second external object after the first external object has pressed and then lifted;
the pressing and then lifting of the second external object after the first external object has pressed and then lifted;
the sliding of the second external object after the first external object has pressed and lifted; and
the sliding in air of the second external object after the first external object has pressed and lifted.

37. The device of claim 33, wherein changing the order of the GUIs in the overlapping area includes:
using the second GUI and the third GUI in the sequential order detected by a touch screen when the first external object is pressing down as a first precedence and a second precedence GUI, respectively;
detecting pressing, lifting, sliding or sliding in air of the second external object by the touch screen while pressing of the first external object has been detected by the touch screen for a first and a second time, respectively, and making the first precedence GUI and the second precedence GUI cover the other GUIs in the overlapping area, respectively

38. The device of claim 33, wherein the processor further changes the order of the GUIs in the overlapping area when pressing, lifting, sliding or sliding in air of a second external object is detected by the touch screen while pressing of a first external object has been detected by the touch screen, and that the pressing of the second external object and/or the pressing, lifting, sliding or sliding in air of the first external object is/are in an overlapping area of two or more GUIs, and thus changing the display of the GUIs, wherein the first external object is at a first side of the second external object, and the second external object is at a second side of the first external object, wherein the first and second sides are opposite sides.

39. The device of claim 38, wherein the processor changing the order of the GUIs in the overlapping area further includes:
detecting pressing, lifting, sliding or sliding in air of the first external object by the touch screen while the second external object has been detected by the touch screen, and thus making the last GUI in the sequential order cover the rest of the GUIs in the overlapping area, wherein the first and second sides are opposite sides;
where when the last GUI in the sequential order is covering the rest of the GUIs in the overlapping area, the second to last GUI in the sequential order becomes the last GUI in the sequential order.

40. The device of claim 39, wherein the processor changing the order of the GUIs in the overlapping area further includes:
using the last GUI and the second to last GUI in the sequential order detected by a touch screen when the first external object is pressing down as a first precedence and a second precedence GUI, respectively; and
detecting pressing, lifting, sliding or sliding in air of the first external object while pressing of the second first external object has been detected by the touch screen for a first and a second time, respectively, and thus making the first precedence GUI and the second precedence GUI cover the other GUIs in the overlapping area, respectively.

41. A method for displaying graphical user interfaces (GUIs), comprising:
displaying a plurality of GUIs on a touch screen, when two or more of the GUIs overlap with each other, these GUIs being arranged in a sequential order which defines a GUI preceding and/or a GUI following the first GUI in the sequential order, wherein the first GUI in the sequential order covers all the following GUIs; and
detecting sliding forward or sliding forward in air of a second external object by the touch screen while pressing of a first external object has been detected by the touch screen, and detecting the pressing of the first external object and/or the sliding forward or sliding forward in air of the second external object in an overlapping area of two or more GUIs, and thus changing the order of the GUIs in the overlapping area so as to change the display of the GUIs.

42. The method of claim 41, further comprising:
detecting sliding forward or sliding forward in air of a first external object by the touch screen while pressing of a second external object has been detected by the touch screen, and detecting the pressing of the second external object and/or the sliding forward or sliding forward in air of the first external object in an overlapping area of two or more GUIs, and thus changing the order of the GUIs in the overlapping area so as to changing the display of the GUIs,
wherein the first external object is at a first side of the second external object, and the second external object is at a second side of the first external object, wherein the first and second sides are opposite sides.

43. A device for displaying graphical user interfaces (GUIs), comprising:
a touch screen for displaying a plurality of GUIs, when two or more of the GUIs overlap with each other, these GUIs being arranged in a sequential order which defines a GUI preceding and/or a GUI following the first GUI in the sequential order, wherein the first GUI in the sequential order covers all the following GUIs; and
a processor for changing the order of the GUIs in the overlapping area when sliding forward or sliding forward in air of a second external object is detected by the touch screen while pressing a first external object has been detected by the touch screen, and that the pressing of the first external object and/or the sliding forward or sliding forward in air of the second external object is/are in an overlapping area of two or more GUIs, and thus changing the display of the GUIs.

44. The device of claim 43, wherein the processor further changes the order of the GUIs in the overlapping area when sliding forward or sliding forward in air of a first external object is detected by the touch screen while pressing of a second external object has been detected by the touch screen, and that the pressing of the second external object and/or the sliding forward or sliding forward in air of the first external object is/are in an overlapping area of two or more GUIs, and thus changing the display of the GUIs, wherein the first external object is at a first side of the second external object, and the second external object is at a second side of the first external object, wherein the first and second sides are opposite sides.

45. A method for displaying graphical user interfaces (GUIs), comprising:
displaying a plurality of GUIs on a touch screen, when two or more of the GUIs overlap with each other, these GUIs being arranged in a sequential order which defines a GUI preceding and/or a GUI following the first GUI in the sequential order, wherein the first GUI in the sequential order covers all the following GUIs; and
detecting lifting, sliding or sliding in air of a second external object by the touch screen while pressing of a first external object and the second external object have been detected by the touch screen simultaneously, and detecting the pressing of the first external object and/or the pressing, lifting, sliding or sliding in air of the second external object in an overlapping area of two or more GUIs, and thus changing the order of the GUIs in the overlapping area so as to change the display of the GUIs.

46. The method of claim 45, further comprising:
detecting lifting, sliding or sliding in air of a first external object by the touch screen while pressing of the first external object and a second external object have been detected by the touch screen simultaneously, and detecting the pressing of the second external object and/or the pressing, lifting, sliding or sliding in air of the first external object in an overlapping area of two or more GUIs, and thus changing the order of the GUIs in the overlapping area so as to change the display of the GUIs,
wherein the first external object is at a first side of the second external object, and the second external object is at a second side of the first external object, wherein the first and second sides are opposite sides.

47. A device for displaying graphical user interfaces (GUIs), comprising:
a touch screen for displaying a plurality of GUIs, when two or more of the GUIs overlap with each other, these GUIs being arranged in a sequential order which defines a GUI preceding and/or a GUI following the first GUI in the sequential order, wherein the first GUI in the sequential order covers all the following GUIs; and
a processor for changing the order of the GUIs in the overlapping area when lifting, sliding or sliding in air of a second external object is detected by the touch screen while a first external object and the second external object have been detected simultaneously, and that the pressing of the first external object and/or the pressing, lifting, sliding or sliding in air of the second external object is/are in an overlapping area of two or more GUIs, and thus changing the display of the GUIs.

48. The device of claim 47, wherein the processor further changes the order of the GUIs in the overlapping area when lifting, sliding or sliding in air of a first external object is detected by the touch screen while the first external object and a second external object have been detected simultaneously, and that the pressing of the second external object and/or the pressing, lifting, sliding or sliding in air of the first external object is/are in an overlapping area of two or more GUIs, and thus changing the display of the GUIs, wherein the first external object is at a first side of the second external object, and the second external object is at a second side of the first external object, wherein the first and second sides are opposite sides.
